(19) United States
(12) Patent Application Publication
(10) Pub. No.: US 2002/0035641 A1
(43) Pub. Date: Mar. 21, 2002

(54) Service allocating device

(76) Inventors: Yoshitoshi Kurose, Kawasaki (JP); Yuji Nomura, Kawasaki (JP); Shinya Kano, Kawasaki (JP)

Correspondence Address: Rosenman & Colin LLP, 575 Madison Avenue, New York, NY, 10022-2585, US

(21) Appl. No.: 09/989,866

(22) Filed: Nov. 19, 2001

Related U.S. Application Data
(63) Continuation of application No. PCT/JP99/03588, filed on Jul. 2, 1999.

(51) Int. Cl. G06F 15/173

(52) U.S. Cl. 709/241; 709/238

(57) ABSTRACT

A service request responding device A and a service request non-responding device B, which are network equipment, are controlled by a service allocating device C. When a user transmits a service request, the service request responding device A requests the network information collecting section (11) of the a service allocating device C to check whether the requested service should be provided. However, the service request non-responding device B passes the service request through the device without performing any processing. On receipt of a service provision availability request, the network information collecting section (11) notifies both a setting device determining section (10) and a service competition section (14) of the request.

### CROSS REFERENCE TO RELATED APPLICATION

This application is a continuation of International PCT Application No. PCT/JP99/03588 filed on Jul. 2, 1999.

### BACKGROUND OF THE INVENTION

1. Field of the Invention

The present invention relates to a service allocating device, and in particular, it relates to a service allocating device for guaranteeing to provide an entire network with services by allocating an appropriate service to a device that cannot provide a requested service, of devices constituting a network with a variety of specifications.

2. Description of the Related Art

Recently, a variety of services are provided in a network. Of the services, there is a service for processing a service request from an outside device and meeting the request. However, of the network-constituting devices, there is a device that cannot provide a specific service despite having a service providing function since the device cannot process the request on receipt of the request. However, it is not practical to replace all the network-constituting devices with such devices for meeting the specific service request, and it demands the utilization of limited network resources.

As service control provided by a specific network-constituting device, quality-of-service (QoS) control and class-of-service (CoS) control are known.

The QoS control dynamically guarantees service quality end-to-end so that video data or audio data may not be interrupted or delayed mid-course, during, for example TV conference. As a protocol for performing such QoS control, a resource reservation protocol (RSVP) is standardized by the Internet Engineering Task Force (IETF). The CoS control is a static service for providing services according to prescribed priority.

The operations of network-constituting devices for providing such different services end-to-end are described below.

FIG. 1 shows the operations of conventional network-constituting devices. FIGS. 1(a), 1(b), and 1(c) show the first, second and third steps, respectively. In this example, for example, a case where a service requester receives the band reservation service of a communications route using RSVP for reserving a band is shown. In FIG. 1, it is assumed that in a communications route connecting a transmitter 1, which is the server of a client-server system, and a receiver 2, which is the client, there are three network-constituting devices: an RSVP responding router 3, an RSVP non-responding router 4, and an RSVP responding router 5. In this example, a target service is for a network constituted by the RSVP responding router 3, RSVP non-responding router 4 and RSVP responding router 5 in a communications route to provide a band reservation service.

In the first step shown in FIG. 1(a), the transmitter 1 transmits a route designation message (path message) to the receiver 2. The route designation message reaches the receiver 2 through the RSVP responding router 3, RSVP non-responding router 4, and RSVP responding router 5. In this case, the RSVP responding routers 3 and 5 store the routing information.

Then, in the second step shown in FIG. 1(b), the receiver 2 transmits a band reservation request message (Resv message) for executing the band reservation request in a route up to the transmitter 1. The RSVP responding routers 3 and 5 judge the band reservation request and execute the band reservation request. Since the RSVP non-responding router 4 cannot execute the band reservation request, the router 4 transfers the band reservation request message to the subsequent router 3 without processing the band reservation request.

Then, in the third step shown in FIG. 1(c), the transmitter 1 transmits data to the receiver 2. In this case, although a band is reversed in the RSVP responding routers 3 and 5, a band is not reserved in the RSVP non-responding router 4. As a result, since a band is not reserved throughout the communications route from the transmitter 1 to the receiver 2, a band reservation service cannot be provided between the transmitter 1 and receiver 2. Thus, the data from the transmitter 1 reach the receiver 2 with part of the data being lost, which is a problem.

If in a communications route, there is a device that cannot process a service request in a communications route, the device cannot provide a service since the service request is neglected. For this reason, a service is not available throughout the network when there is a service request.

FIG. 2 shows the operations of other conventional network-constituting devices. FIGS. 2(a), 2(b), and 2(c) show the first, second, and third steps, respectively. In this configuration, a policy server 6 for managing policy information about a network judges whether a band reservation should be made in response to a band reservation request instead of a router. In this example too, a target service is for a network constituted by an RSVP responding router 3, an RSVP non-responding router 4 and an RSVP responding router 5 in a communications route to provide a band reservation service.

First, in the first step shown in FIG. 2(a), the transmitter 1 transmits a route designation message to the receiver 2, the message reaches the receiver 2 though the RSVP responding router 3, RSVP non-responding router 4, and RSVP responding router 5. The RSVP responding routers store the routing information.

Then, in the second step shown in FIG. 2 (b), the receiver 2 transmits a band reservation request message for executing the band reservation request to a route up to the transmitter 1. On receipt of the band reservation request, each of the RSVP responding routers 3 and 5 makes a request for band reservation permission to a policy server 6 by a Common Open Policy Protocol (COPS) protocol. This COPS protocol exercises admission control (control for determining the permission/non-permission) used when reserving a band by RSVP, which is proposed by the RSVP Admission Policy Work Group (RAP-WG) of the IETF, and the like, based on the policy.

The policy server 6 judges whether the band reservation request should be accepted based on the policy information of the server 6 and returns the judgment result to the RSVP responding routers 3 and 5 making a request for admission. In this example, it is assumed that the reservation request is accepted and the band is reserved in each of the routers 3 and 5. Since the RSVP non-responding router 4 cannot execute the band reservation request, the router 4 transfers the band reservation request message to the subsequent router 3 without processing the band reservation request.

Then, in the third step shown in FIG. 2(c), the transmitter 1 transmits data to the receiver 2. In this case, although the band is reversed in the RSVP responding routers 3 and 5, the band is not reserved in the RSVP non-responding router 4.

As a result, although there is the policy server 6 in the network, the server 6 judges only whether the band reservation request should be accepted and performs no operation against the RSVP non-responding router 4. Therefore, even in a network-constituting device with the policy server 6, the transmitter 1 cannot provide the receiver 2 with a band reservation service, which is a problem.

For information about the network protocols described above, see “Data Networks” by Dimitri Bertsekas and Robert Gallager, Ohm Corporation.

### SUMMARY OF THE INVENTION

The present invention is made from the point of view described above, and it is an object to provide a service allocating device for guaranteeing to provide an entire network with services by setting an appropriate service in a service request non-responding device, which cannot provide a service upon the service request, of network-constituting devices.

The service allocating device of the present invention is provided in a network connecting at least one first device which responds to a network service request and at least one second device which does not respond to the network service request and the setting of which can be modified from outside. The service allocating device comprises a section for obtaining information about a network service provided by the first device, a section for specifying the second device that does not respond to the network service and a section for converting the setting content of the network service that is received by and requested from the first device into a setting content to which the second device can respond, and sets the content obtained by the conversion in the second device. The service allocating device performs control of the setting content of the second device that does not respond to the network service provided by the first device according to the network service request received by the first device.

The service allocating method of the present invention is adopted in a network connecting at least one first device that responds to a network service request and at least one second device that does not respond to the network service request and the setting of which can be modified from outside. The service allocating method comprises the steps of (a) obtaining information about a network service provided by the first device, (b) specifying the second device that does not respond to the network service, (c) converting the setting content of the network service that is received by and requested from the first device, into a setting content to which the second device can respond and (d) setting the content by the conversion in the second device. The service allocating method performs control of the setting content of the second device that does not respond to the network service provided by the first device according to the network service request received by the first device.

According to the present invention, if there are a device that responds to a specific network service and a device that does not respond to the specific network service in a network, a service allocating device obtains information from the device that responds to the network service, specifies the service request non-responding device and makes a setting needed to provide the service request non-responding device with the network service as much as possible. Conventionally, since there is no such service allocating device, the specific network service cannot be provided as the entire network. However, according to the present invention, even if there is a device that responds to the network service and a device that does not respond to the specific network service in a network, the service can be provided.

### BRIEF DESCRIPTION OF THE DRAWINGS

FIG. 1 shows the operations of conventional network-constituting devices; FIGS. 1A, 1B, and 1C show the first, second, and third steps, respectively;

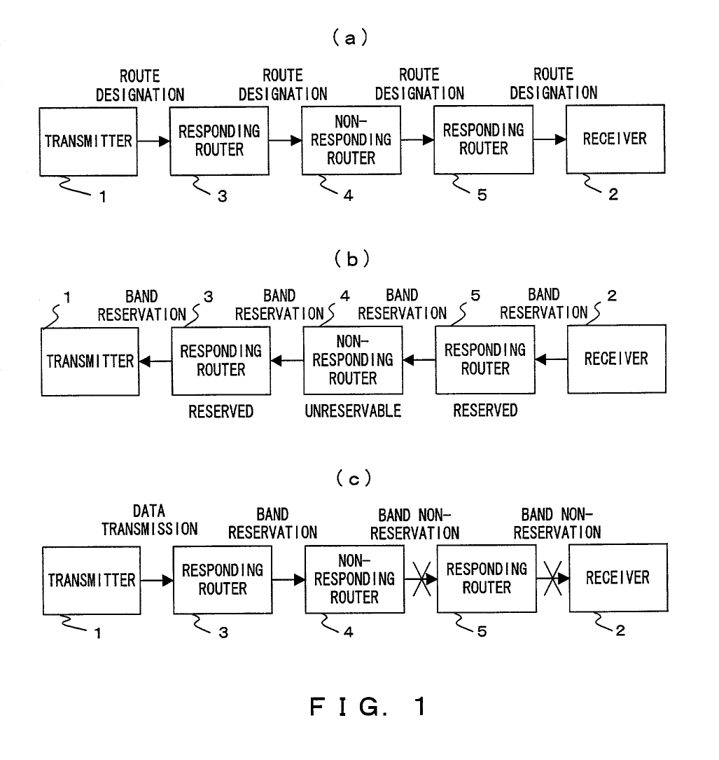

FIG. 2 shows the operations of other conventional network-constituting devices; FIGS. 2(a), 2(b), and 2(c) show the first, second and third steps, respectively;

FIG. 3 shows the first aspect of the present invention;

FIG. 4 shows the second aspect of the present invention;

FIG. 5 shows the third aspect of the present invention;

FIG. 6 shows one network configuration of the first preferred embodiment of the present invention;

FIG. 7 shows both the configuration and operation sequence of device B in the first preferred embodiment;

FIG. 8 shows both the configuration and operation sequence of device A in the first preferred embodiment;

FIG. 9 shows both the configuration and operation sequence of device C in the first preferred embodiment;

FIG. 10 shows tables stored in device C of the first preferred embodiment;

FIG. 11 shows the process flow described with reference to FIGS. 7 through 9 in the comprehensive system configuration;

FIG. 12 is a flowchart showing the process of the service competition calculating section of the service allocating device (device C) in the first preferred embodiment;

FIG. 13 is a flowchart showing the process of the service setting storing section of the service allocating device (device C) in the first preferred embodiment;

FIG. 14 shows one configuration of the second preferred embodiment corresponding to the second aspect of the present invention;

FIG. 15 shows both the configuration and operation sequence of devices A through D in the second preferred embodiment (No. 1);

FIG. 16 shows both the configuration and operation sequence of devices A through D in the second preferred embodiment (No. 2);

FIG. 17 shows both the configuration and operation sequence of devices A through D in the second preferred embodiment (No. 3);

FIG. 18 shows tables stored in device C of the second preferred embodiment;

FIG. 19 shows the comprehensive network configuration of the second preferred embodiment;

FIG. 20 is a flowchart showing the process flow of a priority route selecting section in the second preferred embodiment;

FIG. 21 is a flowchart showing the process flow of a route comparing section in the second preferred embodiment;

FIG. 22 is a flowchart showing the process flow of a route setting generating section in the second preferred embodiment;

FIG. 23 shows one configuration of the third preferred embodiment corresponding to the third aspect of the present invention;

FIG. 24 shows both the configuration and process flow of each device in the third preferred embodiment (No. 1);

FIG. 25 shows both the configuration and process flow of each device in the third preferred embodiment (No. 2);

FIG. 26 shows both the configuration and process flow of each device in the third preferred embodiment (No. 3);

FIG. 27 shows tables stored in device C of the third preferred embodiment;

FIG. 28 shows the comprehensive configuration of the network in the third preferred embodiment;

FIG. 29 is a flowchart showing the process flow of a service stoppage request generating section in the third preferred embodiment;

FIG. 30 is a flowchart showing the process flow of a service competition calculating section in the third preferred embodiment;

FIG. 31 is a flowchart showing the process flow of a service setting storing section in the third preferred embodiment; and

FIG. 32 shows a hardware environment needed by a program to implement the function of device C in each preferred embodiment of the present invention.

### DESCRIPTION OF THE PREFERRED EMBODIMENTS

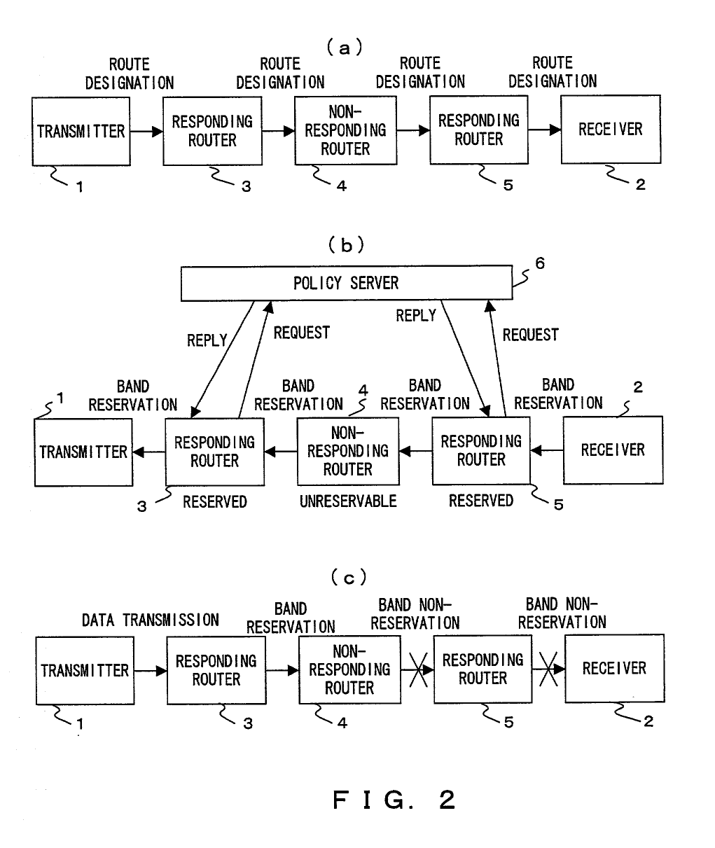

The present invention is described below assuming the network configuration described with reference to FIG. 2.

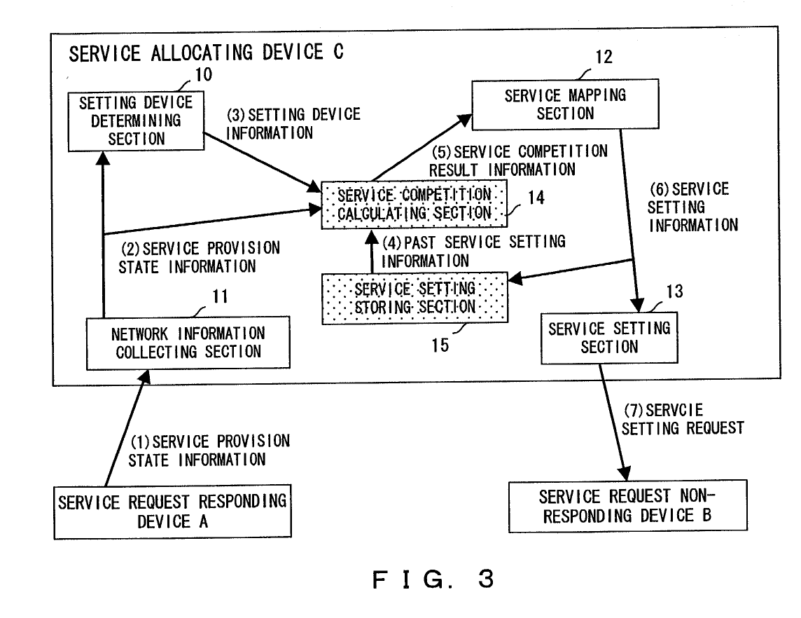

FIG. 3 shows the first aspect of the present invention.

A service request responding device A and a service request non-responding device B are connected by a network, which is not shown in FIG. 3, and a service to which the service request non-responding device B does not respond can be provided to a communications route passing through both the devices A and B.

A service allocating device C, which is a policy server, comprises a network information collecting section 11 for obtaining the service providing state of the network from the service request responding device A, a setting device determining section 10 for specifying a device that does not respond to a requested service based on information from the network information collecting section 11, a service competition calculating section 14, which is described later, a service setting storing section 15, which is described later, a service mapping section 12 for converting (mapping) the service parameters to be set into the parameters of the service request non-responding device specified by the setting device determining section 10 (in this case, the service request non-responding device B), and a service setting section 13 for setting the parameter values obtained by the service mapping section 12 in the real service request non-responding device.

According to the first aspect of the present invention, the service allocating device C, which is a policy server, is newly provided with both a service competition calculating section 14 and a service setting storing section 15.

Specifically, the service setting storing section 15 stores service setting information (6) determined by the service mapping section 12 and transmits previous service setting information (4) to the service competition calculating section 14. The service competition calculating section 14 receives service provision state information (2) from the network information collecting section 11 and also receives setting device information (3) about devices that do not respond to the requested service and in which a parameter must be separately set. Furthermore, the service competition calculating section 14 receives the previous service setting information from the service setting storing section 15 and judges whether the service request is competing, based on the information. If the service request is competing, the service competition calculating section 14 selects/discards a service or modifies the service content, and notifies the service mapping section 12 of service competition result information (5). On receipt of the service competing result information (5), the service mapping section 12 specifies a service to be set, converts this information into a parameter value for enabling as much of the provision of the service as possible, which can be set in the service request non-responding device B, and sets the parameter in the service request non-responding device B through a service setting section (13).

Thus, not only a requested service can be provided using the service request non-responding device B, but the competition relation of service requests is also obtained by comparing the request with previous service situations and the optimal service can be distributed accordingly.

The service request responding device A notifies the network information collecting section 11 of the service allocating device C of service provision state information. The network information collecting section 11 of the service allocating device C notifies both the setting device determining section 10 and service competition calculating section 14 of service provision state information (2) based on the service provision state information (1).

The setting device determining section 10 determines a setting device for providing the service based on the service provision state information (2) and notifies the service competition calculating section 14 of the information as setting device information (3).

The service competition calculating section 14 receives both the service provision state information (2) and setting device information (3), and it also receives the previous service setting information (4) related to both the service content and service setting device from the service setting storing section 15, judges whether priority should be given to the previous service, judges whether the previous service content should be modified, judges whether priority is given to a new service request or a new service request content should be modified, and notifies the service mapping section 12 of the service competing result information (5), which is the judgment result.

The service mapping section 12 generates service setting information (6) for a device in which a service is set, based on the service competing result information (5) and notifies the service setting section 13 of the information.

The service setting section 13 transmits a service setting request (7) to the service request non-responding device B based on the service setting information (6).

Therefore, conventionally, if there is a service request competing with a service currently provided by the network (for example, if resource reservation is centered on a limited resource and the total amount of resource reservation exceeds the capacity of the resource), a service with priority cannot be provided since there is no function to compare a plurality of priority of service provision requests or to adjust the service content. Even if a plurality of services can be essentially provided simultaneously by adjustment, only one of the services can be provided, which is a problem. However, according to the first aspect of the present invention, since a function to judge by comparing competing service requests is added and the setting of service provision can be made, a plurality of competing service requests can be appropriately processed.

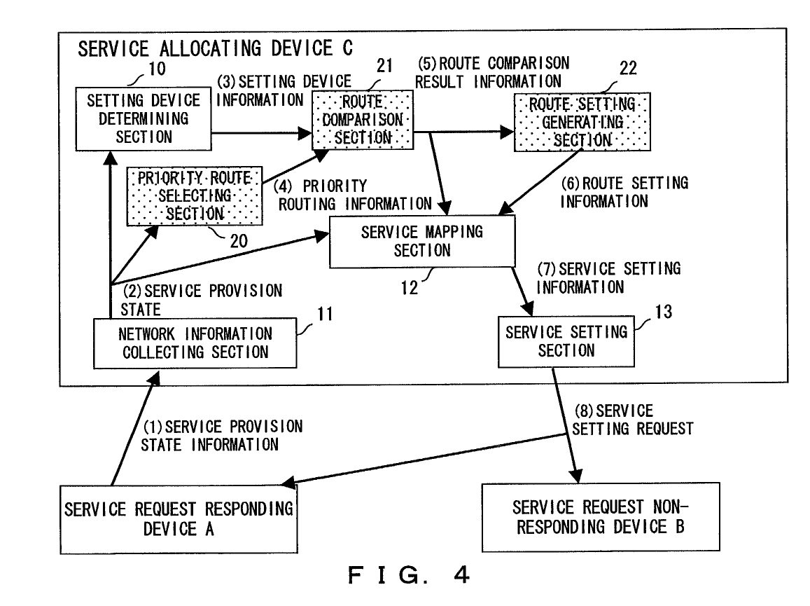

FIG. 4 shows the second aspect of the present invention.

In FIG. 4, the network with the same configuration as that of the first aspect is assumed. The same reference numbers are attached to the same constituent components as those shown in FIG. 3.

In FIG. 4, the service request responding device A receives a service setting request (8) from the service setting section 13 and makes the setting. In this case, since the service request responding device A responds to the service request, the device A can set the service request content without modification.

According to the second aspect, the service allocating device C comprises a priority route selecting section 20, a route comparing section 21 and a route setting generating section 22 in addition to the network information collecting section 11, setting device determining section 10, service mapping section 12, and service setting section 13.

The priority route selecting section 20 selects a route through which the service is provided, based on service provision state information (2) and notifies the route comparing section 21 of the information as priority routing information (4). The route comparing section 21 compares routes and devices in the routes, and determines a route to be selected, based on both setting device information (3) and priority routing information (4), and notifies both the service mapping section 12 and route setting generating section 22 of the route as route comparison result information (5). The route setting generating section 22 generates setting information for rewriting the routing information of each of the devices in both the selected and unselected routes, based on the route comparison result information (5) and notifies the service mapping section 12 of the information as route setting information (6). The service mapping section 12 generates parameters receivable by each device in the route used to provide the service (in this case, both the service request responding device A and service request non-responding device B) from the route setting information (6), route comparing result information (5) and service provision state information (2). The service mapping section 12 has, for example, a table storing information required to determine the parameter and parameter value to be set in a device in response to a specific service request and maps the content of the service request into the parameter of each device using this table. Thus, the service setting information (7) generated by the service mapping section 12 is transmitted to both the service request responding device A and service request non-responding device B as a service setting request (8) by the service setting section 13.

Although according to the first aspect, the service setting section 13 makes a service setting request only to the service request non-responding device B, according to the second aspect, the service setting section 13 also outputs the service setting request (8) to the service request responding device A. This is because if the route generated by the route setting generating section 22 includes a new network device, which has a function equivalent to the service request responding device A but is not used to transfer data from the user that transmits the service request, the service request from the user must be newly accommodated. For this reason, a service setting must also be made in a device that responds to the service request.

Thus, when accommodating a new service request, the service provision state of a network can be optimized by calculating an optimal route and providing a service using this route.

The service request responding device A notifies the network information collecting section 11 of the service allocating device C of service provision state information (1).

The network information collecting section 11 notifies the setting device determining section 10, priority route selecting section 20, and service mapping section 12 of service provision state information (2), based on the service provision state information (1).

The setting device determining section 10 specifies the location of a device to be set, based on the service provision state information (2) and notifies the route comparing section 21 of the location as setting device information (3).

The priority route selecting section 20 avoids a route, the service provision capacity of which is already full, a route, the traffic of which is already heavy, a route, including a device without a service provision function and the like, determines a route suitable for service provision and notifies the route comparing section 21 of the route as priority routing information (4).

The route comparing section 21 compares routes based on both the setting device information (3) and priority routing information (4) and determines a route, through which the service is provided. Then, the route comparing section 21 notifies both the service mapping section 21 and route setting generating section 22 of information about both the selected and unselected routes as route comparing result information (5).

The route setting generating section 22 generates route modification setting information for each device based on the route comparison result information (5) and notifies the service mapping section 12 of the information as route setting information (6).

The service mapping section 12 generates information about the setting items (both the type and value of a parameter) of a device based on service provision state information (2), route comparing result information (5) and route setting information (6), and notifies the service setting section 13 of the information as service setting information (7). The setting items of a device are what should be actually set in each device. For example, it is assumed that the service request non-responding device B is a router with a FreeBSD-based CBQ system. In this case, when the service allocating device C instructs the service request non-responding device B to provide a service for guaranteeing 5 Mbps for communications (communications between IP addresses A and B), the setting items are as follows.

Target: Service request non-responding device B (IP address of device B)

Service target: Communications between IP addresses A and B

Service content: 5 Mbps guaranty queue

Method used when instructing the service request non-responding device B to do something: COPS

The service setting section 13 transmits a service setting request (8) to the service request non-responding device B and the service request responding device A, as requested. On receipt of the service setting request, each device makes the setting and provides the service.

Conventionally, a service is provided only in a route determined by an independently operating network device. Therefore, a request for using a specific route for specific communications cannot be implemented as the entire network. However, according to the second aspect of the present invention, a service can be provided using an arbitrary route by providing the priority route selecting section 20 for determining a preferable route in the service allocating device C, actively determining a priority route, through which a service is provided, compulsorily rewriting the respective settings of both a device in the selected route and a device in the priority route and passing data through the priority route.

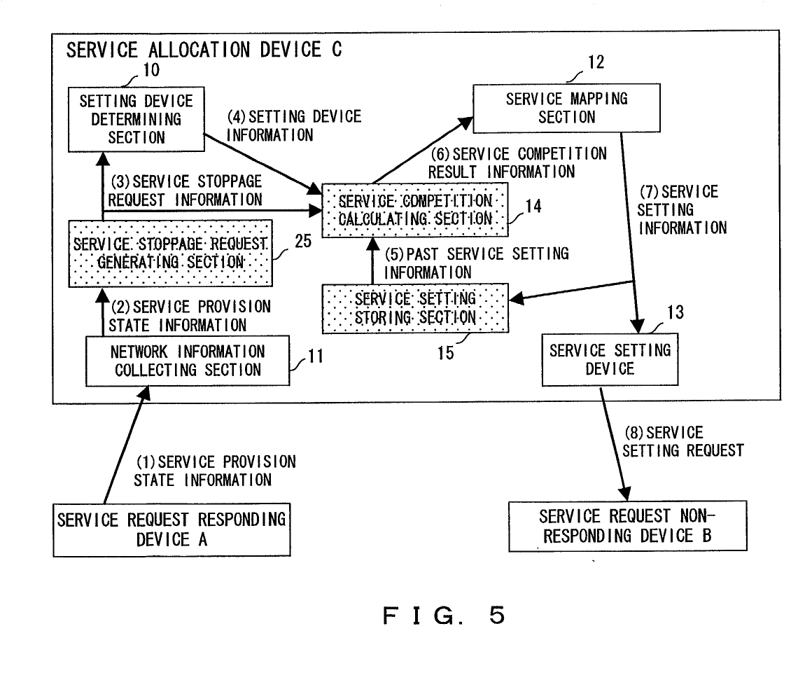

FIG. 5 shows the third aspect of the present invention.

In FIG. 5, the same network configuration as that of the aspects described above is assumed, and the same reference numbers are attached to the same constituent elements as those shown in FIG. 3.

According to the third aspect, the service allocating device C comprises a service stoppage request generating section 25, a service competition calculating section 14 and a service setting storing section 15 in addition to the network information collecting section 11, setting device determining section 10, service mapping section 12 and service setting section 13.

The service stoppage request generating section 25 detects service providing completion based on service provision state information (2) and notifies both the setting device determining section 10 and service competition calculating section 14 of the detection result as service stoppage request information (3). The service setting storing section 13 stores service setting information (7) determined by the service mapping section 12 and transmits previous service setting information (5) to the service competition calculating section 14.

The service competition calculating section 14 receives the service stoppage request information (3) from the service stoppage request generating section 25. The service competition calculating section 14 also receives setting device information (4) and the previous service setting information (5) from the setting device determining section 10 and the service setting storing section 15, respectively. The service competition calculating section 14 compares the service stoppage request information (3) with the previous service providing information (5) based on the plurality of received information. If the two pieces of information are the same, the service competition calculating section 14 determines to cancel the service requested to stop. In this case, if there is another service, the content of which should be modified by the service cancellation, the service competition calculating section 14 determines to modify the service content and notifies the service mapping section 12 of the modification as service competition result information (6).

The service request responding device A notifies the network information collecting section 11 of the service allocating device C of service provision state information (1)

The network information collecting section 11 notifies the service stoppage request generating section 25 of service provision state information (2) based on the service provision state information (1)

The setting device determining section 10 specifies a device, to which service provision should be stopped, based on the service stoppage request information (3) and notifies the service competition calculating section 14 of the device as setting device information (4).

The service competition calculating section 14 receives previous service setting information (5) related to both the service stoppage request content and setting device from the service setting storing section 15 based on both the service stoppage request information (3) and setting device information (4), and determines a service to be modified or cancelled, based on the service stoppage request information (3), setting device information (4) and previous service setting information (5). The service competition calculating section 14 notifies the service mapping section 12 of the determination result as service competition result information (6).

The service mapping section 12 generates the service setting information (7) of a device in which the service setting should be made, and notifies the service setting section 13 of the information.

The service setting section 13 transmits a service setting request (setting specific to the device) (8) to the service request non-responding device B based on the service setting information (7) (or setting for terminating a specific service). The service request non-responding device B provides a service based on the service setting request (8). If the service setting section 13 has ever made the service setting of the service request responding device A, the section 13 also transmits the service setting request (8) to the service request responding device A. Specifically, the service allocating device C can also make a service setting in the service request responding device A. Therefore, if the service request responding device A is designed to receive a service setting request from the service allocating device C and receives the service setting request from the service allocating device C at the time of service provision, the service sometimes cannot be terminated only by the service request responding device A. In order to terminate the service in the entire communications route, the service allocating device C must instruct not only the service request non-responding device B to terminate the service, but also must instruct the service request responding device A to terminate the service. In this case, there are two cases.

1. A case where although the service request responding device A has already terminated the service, the service request non-responding device B still continues to provide the service.

2. A case where both the service request responding device A and service request non-responding device B continue to provide the service.

In case (1), it is allowable if the service allocating device C designates the service termination setting only for the service request non-responding device B. However, in case (2), the service allocating device C must designate the service termination setting for both the devices A and B.

Conventionally, although a service setting or the modification are made for a device in a network by a service request, setting modification accompanying the termination of service provision of each device is not possible by the termination of a service provision request. However, according to the third aspect of the present invention, service provision can be stopped by detecting the termination of the service provision request in the service stoppage request generating section 25, processing the information as a service stoppage request and making a setting modification in a device through which the service is provided. As a result, needless service provision in a network can be stopped.

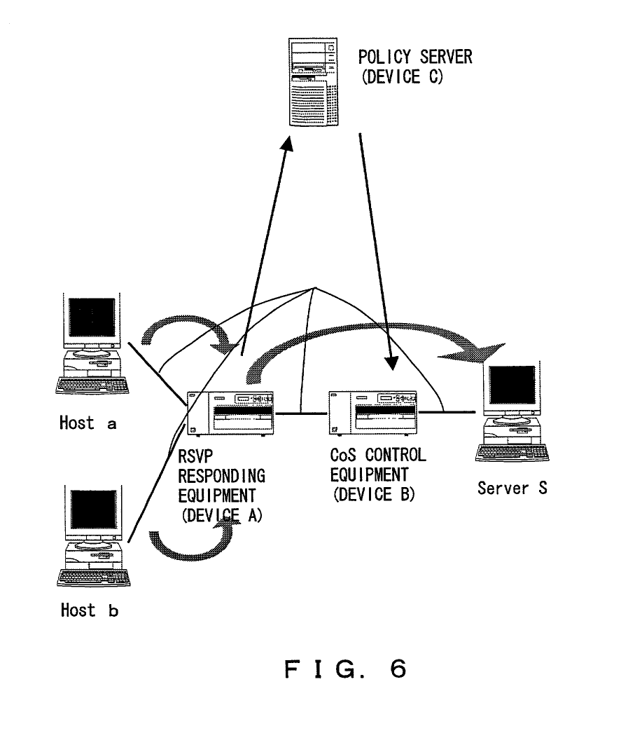

FIG. 6 shows one network configuration in the first preferred embodiment of the present invention.

This preferred embodiment corresponds to the aspect of the present invention described above.

In this preferred embodiment, when hosts a and b make competing service requests (reservation request (RSVP)) to the same device group, the policy server (device C) adjusts the competing service requests of a CoS control device (RSVP non-responding device B) and makes the setting. As a result, in this preferred embodiment, a network for processing competing service requests can be configured.

The network of this preferred embodiment comprises hosts a and b, a server and devices A, B and C. It is also assumed that the devices are connected by a data transmitting medium (, such as a cable). The internal operation of each device is described later.

In this preferred embodiment, hosts a and b are end terminals, such as personal computers for receiving QoC control and CoS control in communications. These hosts are connected to a network. Therefore, each of the hosts can make a service request to the network by receiving a path message (RSVP) issued by a server, which is described later, and transmitting a Resv message (RSVP). The policy server (device C) stores both information about a user using a terminal and the IP address information of the terminal since those pieces of information are used in each processing section of the policy server. In this preferred embodiment, the IP addresses of hosts a and b are a and b, respectively.

Server S has a function to transmit data to the end terminals as an application server. This server S is connected to the network. Therefore, server S can transmit a path message (RSVP), and receive/process a Resv message (RSVP). The policy server (device C) also stores both information about the application of server and the IP address information since those pieces of information are used in each processing section of the policy server. In this preferred embodiment the IP address of server S is S.

Device A is an RSVP responding router. Therefore, device A can receive/process an RSVP message and provide a service. On receipt of a service request, for example, device A requests the policy server (device C) to judge whether the request should be provided using a COPS and follows the reply based on the judgment. Device A has a band reservable queue (data communications buffer) The queue number of a queue for making a band reservation of 10 Mbps and the queue number of a queue for making a band reservation of 5 Mbps are 2 and 1, respectively. The IP address of device A is A.

Device B is an RSVP responding CoS-controllable router and can set CoS controls from outside. Since device B cannot process an RSVP message, device B passes the message though device B without performing any processing. Device B has three queues with priority (high-, middle-, and low- priority queues). The queue numbers of the three queues are 3, 2, and 1, respectively. The IP address of device B is B.

Device C is a service allocating device (policy server). Device C can receive a service provision availability request using a COPS from network equipment, judge whether the request is acceptable using a band reservation judgment table stored in device C and can reply to the request using a COPS. When responding to a request transmitted using a COPS, device C obtains the IP addresses of both a host requesting a service and a communicating server, a user name, a requested band value and the like, and uses the data for the operation in device C.

By obtaining transmitter/receiver IP addresses, device C specifies a router for relaying generated transmitting/receiving data using the setting device determining section. If for an IP routing protocol, an open shortest path first (OSPF) is used in the network, device C can receive the link state advertisement (LSA) packet of the OSPF broadcast in the network. Specifically, since the LSA packet includes the topology information of the router, on receipt of the information, device C can obtain the topology (store the topology as a routing information table) and calculate the shortest path based on both the transmitter/receiver IP addresses using Dijkstra's algorithm (see the reference mentioned in Description of the Related Art). As a result, device C can specify a relay router by calculating an IP route. Device C can obtain a current setting state using the IP address of the relay router specified by information from both a dynamic network information table and a service setting storing section. A setting state includes a settable parameter, an already set parameter, a protocol used for setting, a setting method and the like. Device C can generate a setting value peculiar to each relay router using both a service mapping table and a service mapping function based on both the setting state information of the relay router and the transmitting/receiving IP addresses (transmitter IP address and receiver IP address), user name and requested band value which are obtained using a COPS. Device C transmits a setting request generated using a simple network management protocol (SNMP) to each router and reflects the setting in each router. Thus, a setting based on a service request can be made in device B, which cannot provide a service in the network although there is a service request.

When there are service requests that compete in a network, the service competition calculating section can process the requests using the data in a band reservation judgment policy table or a service setting storing section. Therefore, an appropriate judgment can be made and an adjusted service setting can be generated. Accordingly, an appropriate service can be provided throughout the entire network.

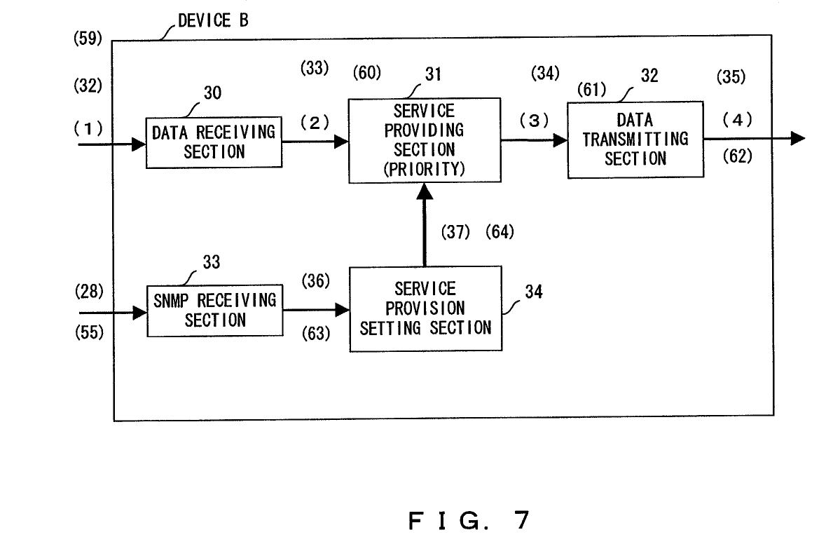

FIGS. 7, 8, and 9 show the configurations and operation sequences of devices B, A, and C, respectively, in the first preferred embodiment.

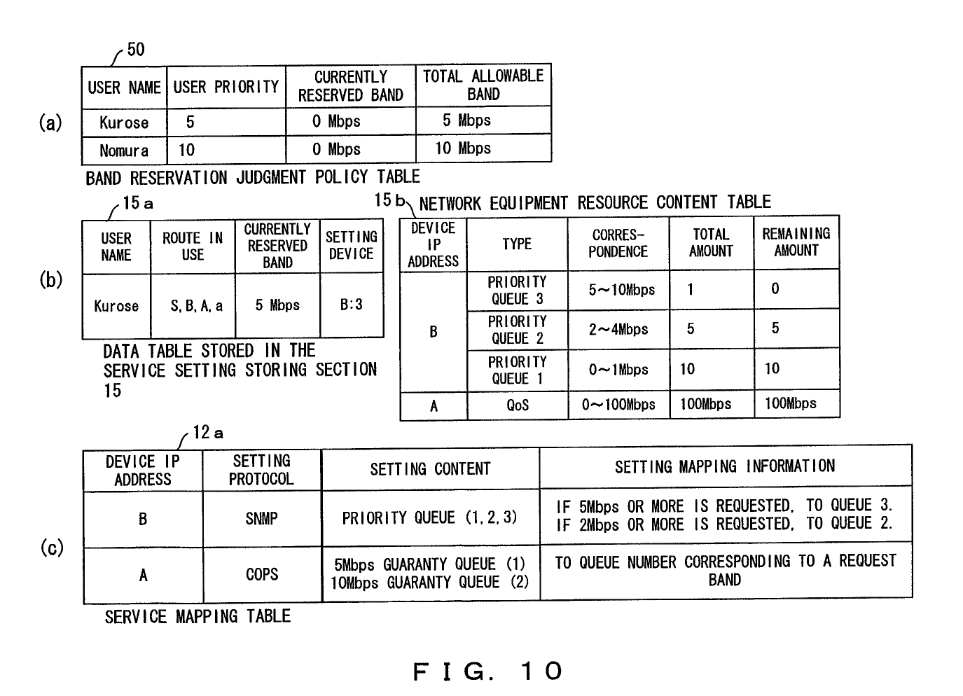

FIG. 10 shows tables stored in device C.

The operation of this preferred embodiment is described below with reference to FIGS. 7 through 10.

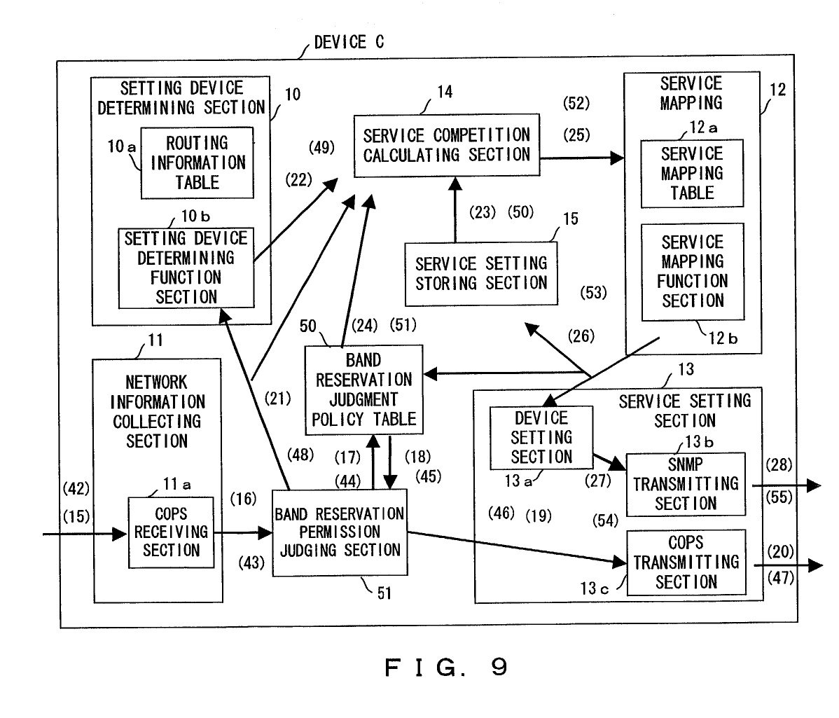

In FIG. 9, the same reference numbers are attached to the same constituent components as those shown in FIG. 3.

First, server S transmits a path message (RSVP) to device B shown in FIG. 7. Although device B receives the path message (1), as shown in routes (2), (3), and (4), device B transmits the message to device A through a data receiving section 30, a service providing section 31 and a data transmitting section 32 without performing any processing.

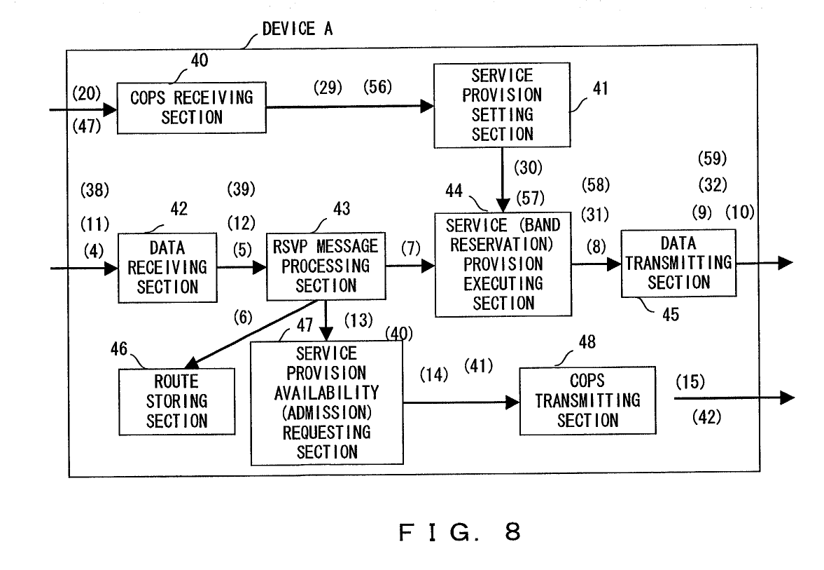

When receiving the path message in a data receiving section 42 (4), device A shown in FIG. 8 transmits the message to an RSVP message processing section 43 (5) and stores the routing information of the path message in a routing storing section 46 (6). Furthermore, device A transmits the path message to a data transmitting section 45 through a service provision executing section 44, as shown in (7) and (8), and transmits the path message from the data transmitting section 45 to hosts a and b as shown in (9) and (10).

On receipt of the path message, host a transmits a Resv message to server S in order to receive a band reservation service. For example, the user name and reservation band of the band reservation request are assumed to be Kurose and 5 Mbps, respectively. Device A receives the Resv message in a data receiving section 42 (11) and notifies an RSVP message processing section 43 of the Resv message (12). The RSVP message processing section 43 transmits service provision availability request information to device C from a COPS transmitting section 48 (15) through a service provision availability requesting section 47 (13) and (14). The transmitting information includes the transmitting/receiving IP addresses (S and a), user name, Kurose, and requested band, 5 Mbps.

Device C receives the transmitting information from device A in the COPS receiving section 11a of a network information collection section 11 (15) and transmits the service provision availability judgment request of the band reservation request from device A to a band reservation permission judging section 51 (16) On receipt of the request, the RSVP message processing unit 43 obtains the data of a band reservation judgment policy table 50 (see FIG. 10) (17) and (18), and judges whether both user name, Kurose, and requested band, 5 Mbps should be accepted, based on the data. According to the band reservation judgment policy table 50 shown in FIG. 10A, since the maximum band 5 Mbps is permitted for the user name, Kurose, and that the current band in use is 0 Mbps, it is judged that this service request should be accepted.

This permission judgment result is transmitted to the COPS transmitting section 13c of a service setting section 13 (19), and the COPS transmitting section 13c transmits the permission judgment result to device A as a service provision availability judgment result (20) In this example, since the permission judgment is reported, the band reservation permission judgment section 51 transmits the IP address A of device A that transmits both transmitting/receiving IP addresses (S, a) and data, to a setting device determining section 10 and transmits the transmitting/receiving IP addresses (S, a), user name, Kurose, and requested band, 5 Mbps to a service competition calculating section 14 (21).

The setting device determining section 10 can judge that a relay route should consist of host a, device A, device B, server S (a, A, B and S), based on the IP addresses (S, a and A) obtained from a band reservation permission judging section 51, route information table 10a (topology information) and a setting device determining function section 10b (calculation using Dijkstra's algorithm), and transmits the relay routing information to a service competition calculating section 14 (22).

The service competition calculating section 14 confirms that a service is currently provided in the route, based on the relay routing information obtained from the setting device determining section 10. For this confirmation information, the service competition calculating section 14 uses information of a service setting storing section 15 (23). The service competition calculating section 14 also refers to the band reservation judgment policy table 50 as requested (24). If a service is not provided in the current route (S, B, A, and a), the service competition calculating section 14 transmits user name, Kurose, requested band, 5 Mbps, and route in use (S, B, A and a) to a service mapping section 12 as service competition result information (25).

The service mapping section 12 specifies device B as a relay router to be set and obtains from a service mapping table 12a (FIG. 10(c)) information indicating that the service should be set in the queue with queue number 3 of the device B if the service can be set using an SNMP protocol and the requested band of the service is 5 Mbps or more. Then, the service mapping function section 12b of the service mapping section 12 generates service setting information indicating that communications between the transmitting/receiving IP addresses (S, a) should be conducted in a high-priority queue with queue number 3 for device B with IP address B, using these pieces of setting information. The service mapping section 12 also transmits the generated service setting information to the service setting storing section 15, the band reservation judgment policy table 50 and the device setting section 13a of the service setting section 13 (26). Both the service setting storing section 15 and band reservation judgment policy table 50 modifies stored data based on the receiving information from the service mapping section 12.

The device setting section 13a of the service setting section 13 generates service setting request information for SNMP, based on the receiving information from the service mapping section 12 and transmits the setting request information to an SNMP transmitting section 13b (27). The SNMP transmitting section 13b transmits the service setting request information to device B, which is the setting target, using an SNMP, based on the setting request information from the device setting section 13a (28).

Device A receives the service provision permitting judgment result in the COPS receiving section 40 (20). The COPS receiving section 40 transmits the received service provision permitting judgment result to a service provision setting section 41 (29). The service provision setting section 41 sets a service provision executing section 44 based on the service provision permitting judgment result received from the COPS receiving section 40 (30) and starts to provide host a with the service. As shown in (31) and (32), the service provision setting section 41 transmits a Resv message to device B through the service provision executing section 44 and data transmitting section 45.

Device B receives the Resv message in a data receiving section 30 (32). Since device B cannot process an RSVP message, as shown in (33), (34) and (35), device B transmits the Resv message to server S through a data transmitting section 32 without performing any processing. However, device B receives the service setting request information from device C (28). As shown in (36), the service setting request information received in an SNMP receiving section 33 is transmitted to a service provision setting section 34. The service provision setting section 34 makes the setting of using a queue with queue number 3 for communications between transmitting/receiving addresses (S, a) based on the service setting request information (37). As a result, in device B, a high-priority queue with queue number 3 is used for the communications between transmitting/receiving addresses (S, a), and the provision of the service to host a is started.

On receipt of a path message, host b transmits a Resv message to server S in order to receive the band reservation service. For example, the user name and reservation band of the band reservation request are assumed to be Nomura and 10 Mbps, respectively.

Device A receives the Resv message from host b in a data receiving section 42 (38) and notifies an RSVP message processing section 43 of the message (39). When the RSVP message processing section 43 receives the Resv message, a service provision availability requesting section 47 transmits a service provision availability request to device C using a COPS transmitting section 48 (40, 41 and 42). The transmitting data includes the transmitting/receiving IP addresses (S and a), user name, Nomura and requested band, 10 Mbps.

Device C receives the transmitting data from device A in a COPS receiving section 11a, transmits the data to a band reservation permission judging section 51 (43) and makes the band reservation permission judging section 51 judge whether the service should be provided. The band reservation permission judging section 51 obtains the data of the band reservation judging policy table 50 (FIG. 10A) and judges whether the service of requested band, 10 Mbps, should be provided to user name, Nomura. In this case, since according to the band reservation judging policy table 50, the maximum, 10 Mbps, that is permitted for user name, Nomura, and that the current band in use is 0 Mbps, and device C judges that this service should be provided. This permission result is transmitted to the COPS transmitting section 13c (46). Then, the COPS transmitting section 13c transmits the service provision availability judgment result to device A (47).

In this example, since it is judged that the service provision is permitted, the band reservation permission judging section 51 transmits both the transmitting/receiving IP addresses (S and a) and the IP address, A of device A that transmits the data to the setting device determining section 10 and transmits the transmitting/receiving IP addresses (S and a), user name, Nomura, and requested band, 10 Mbps, to the service competition calculating section 14 (48). The setting device determining section 10 judges that the relay route should consist of host b, device A, device B and a server (b, A, B, and S) based on the IP addresses (S, b and A) obtained from the band reservation permission judging section 51, routing information table 10a (topology information) and setting device determining function section 10b (calculated using Dijkstra's algorithm), and transmits the relay routing information to the service competition calculating section 14 (49).

The service competition calculating section 14 confirms that a service is currently provided in the route, based on the relay routing information obtained from the setting device determining section 10. For the confirmation information, the service competition calculating section 14 uses the information of the service setting storing section 15 (50). The service competition calculating section 14 also refers to information in the band reservation judgment policy table 50 as requested (51). According to the information of the service setting storing section 15, a service is already provided in the current route (S, B, A, and b) for user name, Kurose (FIG. 10B). As a result, since the user priorities of Kurose and Nomura in the band reservation judgment policy table 50 (see FIG. 10A) are 5 and 10, respectively, the service competition calculating section 14 judges that priority should be given to the service of user name, Nomura. In that case, although the service content of Nomura's request, that is, user name, Nomura, requested band, 10 Mbps, and the route in use (S, B, A and b) remains the same, the service content of user name, Kurose, is modified to user name, Kurose, requested band, 3 Mbps, and the route to be used (S, B, A and a), and the modified setting information is transmitted to the service mapping section 12 (52).

The service mapping section 12 specifies device B as a relay router to be set, based on the received setting information and obtains from a service mapping table 12a (FIG. 10(c)) information indicating that the service should be set in a queue with queue number 3 if the service can be set using an SNMP protocol and the requested band of the service is 5 Mbps or more. A service mapping function section 12b generates setting information indicating that communications between transmitting/receiving IP addresses (S and b) should be conducted in a high-priority queue with queue number 3 for device B with IP address B using the information as the service setting information of host b. The service mapping function section 12b also generates new service setting information indicating that communications between transmitting/receiving IP addresses (S and a) should be conducted in a middle-priority queue with queue number 2 for device B with IP address B using the information as the service setting information for the modified communications of host a. The service mapping function section 12b transmits the generated service setting information to the service setting storing section 15, the band reservation judgment policy table 50 and a device setting section 13a (53). Data stored in both the service setting storing section 15 and band reservation judgment policy table 50 are modified based on the service setting information from the service mapping section 12. The device setting section 13a generates service setting request information for SNMP, based on the service setting information from the service mapping section 12 and transmits the setting request information to an SNMP transmitting section 13b (54). The SNMP transmitting section 13b transmits the service setting request to device B, which is the setting target, using an SNMP, based on the data from the device setting section 13a (55).

Device A receives the service provision permission result in the COPS receiving section 40 (47), sets the service provision executing section 44 using the service provision setting section 41 based on the receiving data from the COPS receiving section 40 (56 and 57) and starts to provide host b with the service. Device A also transmits a Resv message to device B from the data transmitting section 45 (58 and 59).

Although device B receives the Resv message from device A (59), device B cannot process an RSVP message. Therefore, device B transmits the message to server S without performing any processing, as shown in (60), (61), and (62). Device B also receives the service setting request information from device C in the SNMP receiving section 33 (55), and as shown in (63) and (64), the service provision setting section 34 makes a setting such that a queue with queue number 3 can be used for communications between transmitting/receiving IP addresses (S and b) in a service providing section 31 based on the information. As a result, in device B, a high-priority queue with queue number 3 is used for the communications between transmitting/receiving IP addresses and the service provision to host b is started. Simultaneously, the section 34 also makes a setting such that a queue with queue number 2 is used for communications between transmitting/receiving IP addresses (S and a) in the service providing section 31. As a result, in device B, a middle-priority queue with queue number 2 is used for the communications between transmitting/receiving IP addresses (S and a) and the service provision to host a is started.

FIGS. 10(a), 10(b), and 10(c) show the band reservation judgment policy table 50, the data table of the service setting storing section 15 and the service mapping table 12a, respectively.

As shown in FIG. 10(a), the band reservation judgment policy table 50 stores a user name, a user priority, a currently reserved band and a total allowable band. As described earlier, when a new user makes a request, the band reservation judgment policy table 50 obtains the user priority and allocates with priority a band to a high-priority user. If the currently reserved band is smaller than the total allowable band, the service provision is permitted.

The service setting storing section 15 has two tables: a table 15a for storing currently set service setting information, which is shown in the left of FIG. 10(b) and a table 15b for storing the resource content of network equipment, which is shown in the right. When a new user receives a service and the number of services that the network provides is increased, the table 15a for storing currently set service setting information is updated according to an update instruction from the service mapping section 12. The network equipment resource content table 15b indicates the resource content of each piece of equipment included in the network. In the example shown in FIG. 10(b), device B can be specified by device IP address B and has three types of priority queues. However, device B does not respond to QoS. The band that can accommodate these queues is described in the “response” column of the table, and one example is shown in FIG. 10(b). In addition, the network equipment resource content table 15b stores both the total amount and remaining amount of each queue (each resource). The table 15 also stores the total amount and remaining amount of device A, which can be specified by device IP address A. It stores information indicating that device A responds to QoS and can respond to a band of 0 to 100 Mbps. The table 15b is generated by a manager setting the quality assurance type, quality assurance limit, current service provision capacity and the like of each piece of network equipment in advance.

The service mapping table 12a stores a device IP address, a setting protocol, a setting content and setting mapping information. Device B is provided with priority queues (1, 2, and 3) depending on the setting contents. The service mapping table 12a stores information indicating that the service should be mapped into queue 3 if the requested band is 5 Mbps or more and that the service should be mapped into queue 2 if the requested band is 2 Mbps or less. Device A is provided with two types of queues and the service can be set in a queue number corresponding to the requested band. A protocol to be used to transmit setting information to device A is COPS.

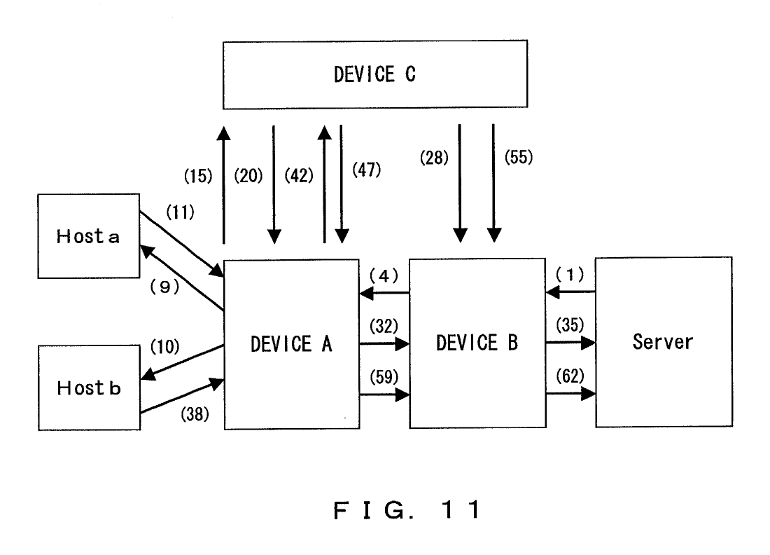

FIG. 11 shows the comprehensive system configuration of the process flows described with reference to FIGS.7 through 9.

Numbers shown in FIG. 11 corresponds to the numbers shown in FIGS. 7 through 9. As described earlier, every time there is a service request from host a or b, device A asks device C for service setting permission and allocates a band to host a or b in accordance with the content of the obtained service permission. Device B directly receives a setting request from device C in accordance with the service content setting made by device A. Therefore, even if devices A and B are a service responding device and a service non-responding device, respectively, a service meeting a service request can be provided in network connecting devices A and B.

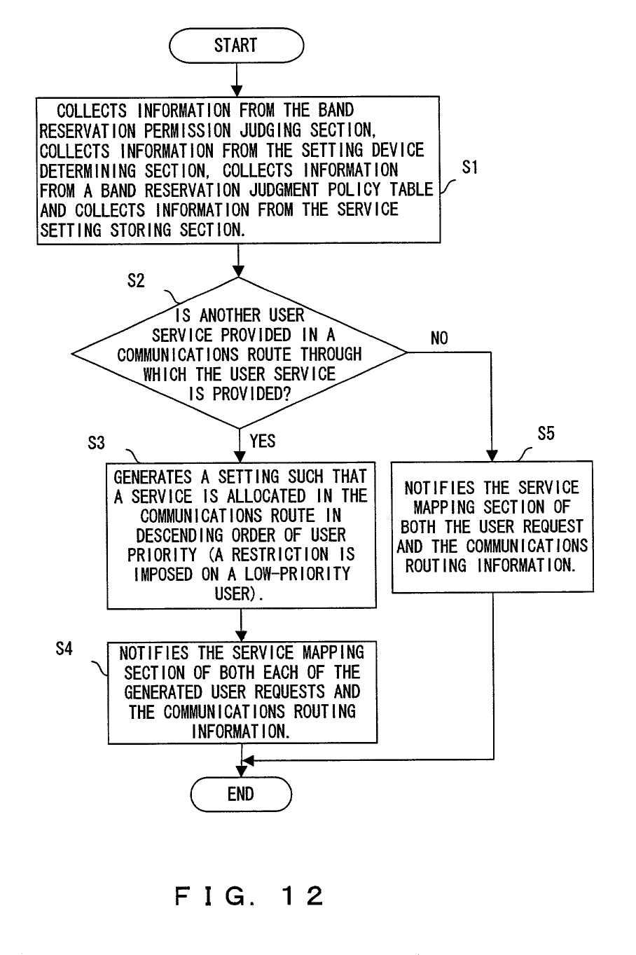

FIG. 12 is a flowchart showing the process of the service competition calculating section 14 of the service allocating device (device C) in the first preferred embodiment.

First, in step S1, information is collected from each of the band reservation permission judging section 15, setting device determining section 10, band reservation judgment policy table 50 and service setting storing section 15. Then, in step S2, it is judged whether a service is provided to another user through the communication route through which the service is to be provided to the user. If it is judged that a service is not provided, in step S5, both the user request and communications routing information are reported to the service mapping section 12.

If in step S2, a service is provided to another user, in step S3, the service content is set in such a way that the service can be allocated to a user in descending order of user priority in the communications route. Specifically, as described above, a restriction is given to a lower-priority user, like user name, Kurose Then, in step S4, both the service request content and communications route of each user that are newly set are reported to the service mapping section 12.

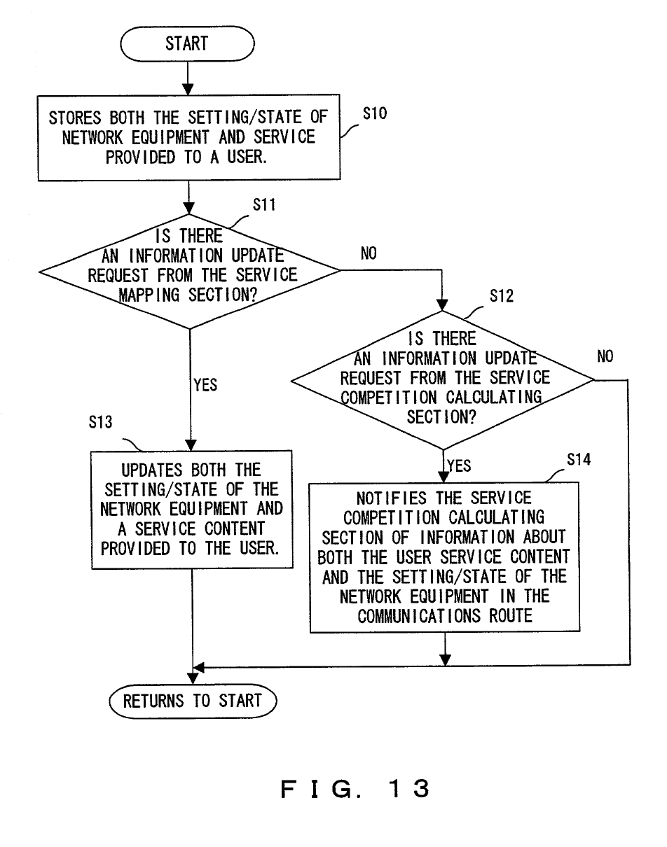

FIG. 13 is a flowchart showing the process of the service setting storing section 15 of device C in the first preferred embodiment.

First, in step S10, both the setting/state of each of a plurality of pieces of network equipment and the service content provided to each user are stored. Then, in step S11, it is judged whether an information update request is received from the service mapping section 12. If the request is received, in step S13, the setting/state of each of the plurality of pieces of network equipment and the service content provided to each user are updated.

If in step S11 the request is not received, in step S12, an information request is received from the service competition calculating section 14. If the information request is received, in step S14, both the service content of each user and the setting/state of each of the plurality of pieces of the network equipment are reported to the service competition calculating section 14.

If in step S12 it is judged that the information request is not received from the service competition calculating section 14, the process returns to the start.

Although in the first preferred embodiment, a router in the communication route between a host and a server is detected using OSPF, topology or an IP communications route can also be detected using another routing protocol, such as a routing information protocol (RIP). Alternatively, a network management protocol, such as SNMP can be used.

Alternatively, usually service provision setting data can be stored in device C instead of a device other than C and the data can be obtained from the device C using a network management protocol, such as SNMP, or a Telnet protocol, as requested.

Furthermore, although device C uses SNMP as a protocol for external setting transmission, a Telnet protocol, COPS, a command line interface (CLI) and the like can also be used.

Alternatively, usually network data (user information, device information, etc.) can be stored in a device other than C instead of device C, and device C can obtain the data from the device other than C, as requested.

Furthermore, although in the first preferred embodiment, a setting is made in a device corresponding to device B in a relay route, the setting can be set only in a predetermined router or a service provision setting can be made in a switch device in a MAC layer (layer 2 switch, etc.) other than a relay router in the route, a layer 3 switch, an ATM switch, and the like.

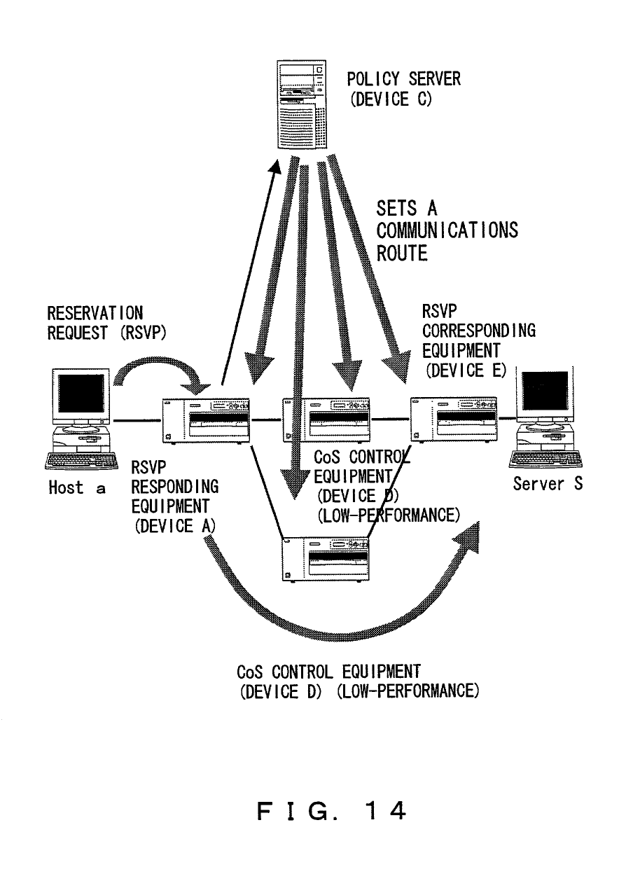

FIG. 14 shows one configuration of the second preferred embodiment corresponding to the second aspect of the present invention.

In this preferred embodiment, if host a makes a service request (reservation request: RSVP) for communications with a server, usually the communications are conducted from host a to the server through devices A and B. However, if the policy server (device C) judges that device D meets the service request better than device B and modifies the routing information of each device, the route can be modified to a more appropriate route (host a, device A, device D and server) than the usual route. As a result, a network in which a variety of devices in a network are effectively used can be configured.

The network of this preferred embodiment comprises host a, server S, device A, device B, device C, and device D. Each device is connected to each other device by a data transmission medium (transmission line).

In this preferred embodiment, host a is an end terminal, such as a personal computer for receiving both QoS and Cos control services in communications. This host is connected to a network, and host a can receive a path message (RSVP) outputted by a server, which is described later, transmit a Resv message and make a service request to the network. Both the information about the user of the terminal and IP address information of the terminal are stored in the policy server (device C) for use in the processing section of the policy server. In this preferred embodiment, the IP address of host a is a.

In this preferred embodiment, server S has a function to transmit data to an end terminal as an application server. This server S is also connected to the network, and sever S can transmit a path message (RSVP), and receive/process a Resv message (RSVP). Both the application information and IP address information of server S are stored in the policy server (device C) for use in the processing section of the policy server. In this preferred embodiment, the IP address of server S is S.

Devices A and E are RSVP responding routers, and can receive an RSVP message, process the message and provide a service. On receipt of a service request, each of the devices A and E makes a service provision availability judgment request to the policy server (device C) using COPS and follows the availability reply. Each of devices A and E has a band reservable queue (data communications buffer), and the queue number of a queue for making a 10 Mbps band reservation and a queue number of a queue for making 2.5 Mbps band reservation is 2 and 1, respectively. The IP addresses of devices A and E are A and E, respectively. Each of the devices A and E receives a routing information modification request from outside and resets routing information.

Devices B and D are RSVP non-responding Cos-controllable routers, and both the Cos control and routing information settings of each of devices B and D can be made externally. Since each of the devices B and D cannot process an RSVP message, the RSVP message is passed through both devices B and D without performing any processing. Device B has three queues (high-priority, middle-priority and low-priority) and the queue numbers are 3, 2, and 1, respectively. Device D has two queues (high-priority and low-priority) and the queue numbers are 2 and 1, respectively. The IP addresses of devices B and D are B and D, respectively.

Device C is a service allocating device (policy server). Device C can receive a service provision availability request by COPS from network equipment, judges the availability based on a band reservation judgment table stored inside and returns a reply using COPS. When replying to the request by COPS, device C can obtain the IP addresses of a host that makes a service request and a communicating server, a user name, a band requested value and the like and can use those pieces of data in the calculation and in operation within device C.

By obtaining transmitter/receiver IP addresses, device C also specifies a router for relaying generated transmitting/receiving data using a setting device determining section, which is not shown in FIG. 14. In a network using OSPF as an IP routing protocol, device C can receive the LSA packet of OSPF broadcast in the network, in the setting device determining section. Specifically, since the LSA packet includes the topology information of the router, device C can obtain the topology (stores it as a routing information table) on receipt of the packet and can calculate the shortest path based on the IP transmitting/receiving addresses (transmitter IP address and receiver IP address) using the Djikstra's algorithm. As a result, in device C, a relay router can be specified by calculating the IP route. Based on dynamic network information obtained using SNMP or each piece of device information, a route suitable for, or a route not suitable for, each service provision can be specified.

Device C can generate a setting value peculiar to each relay router in the service mapping table or service mapping section, which is not shown in FIG. 14, based on both the setting state information of a relay router and the transmitting/receiving IP addresses, user name, and requested band value, which are obtained by COPS. Device C transmits the setting generated using SNMP to each router to reflect the setting on each router. Thus, a service request can be set even in device B, which cannot usually provide a service although there is a service request in a network. Similarly, routing information setting can be transmitted using SNMP and the network routing of a communications route can be modified.

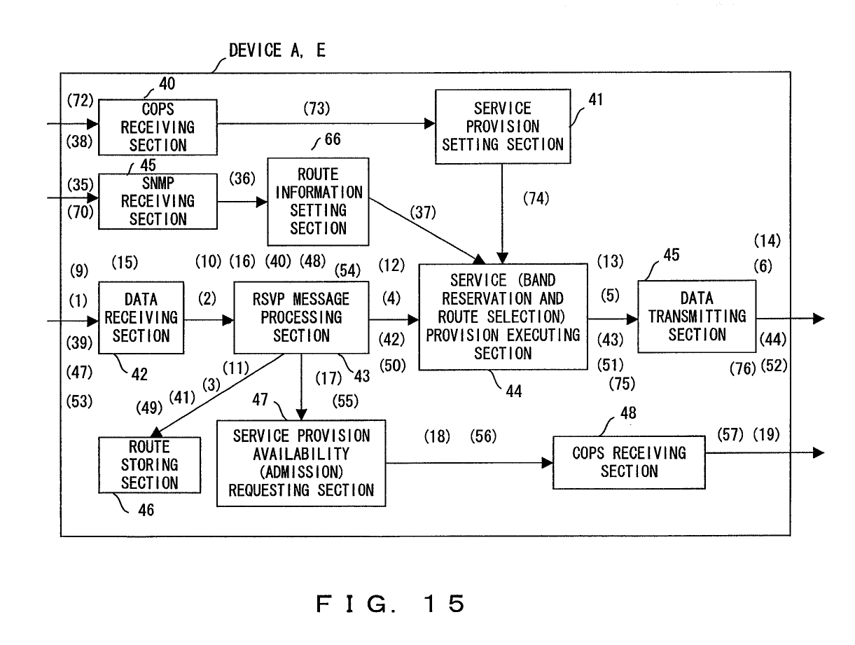

FIGS. 15 through 18 show the configuration of devices A through D and operational sequences according to the second embodiment.

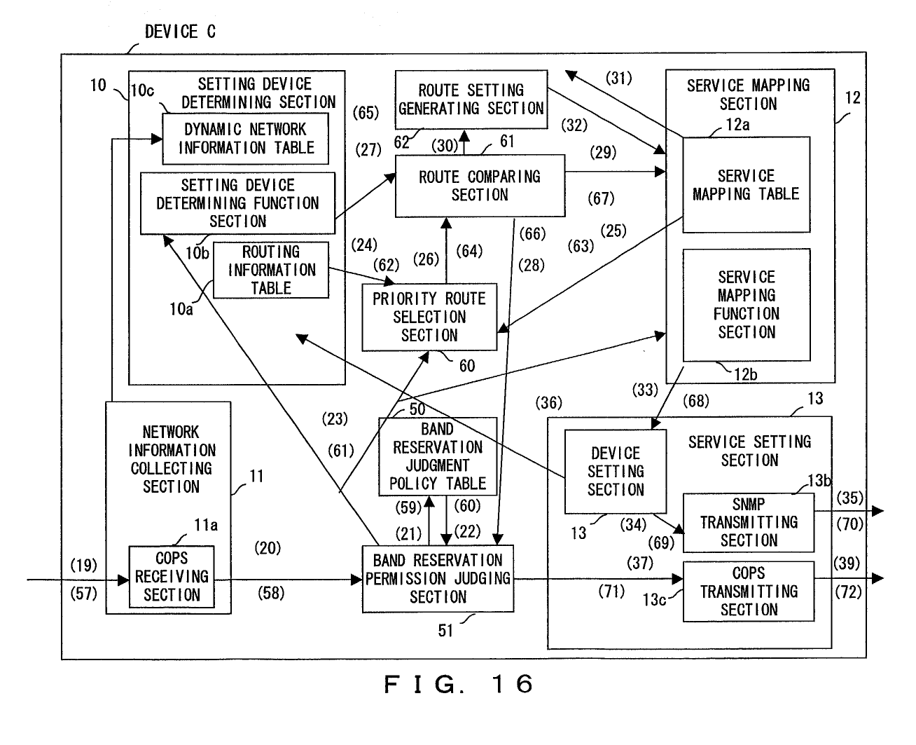

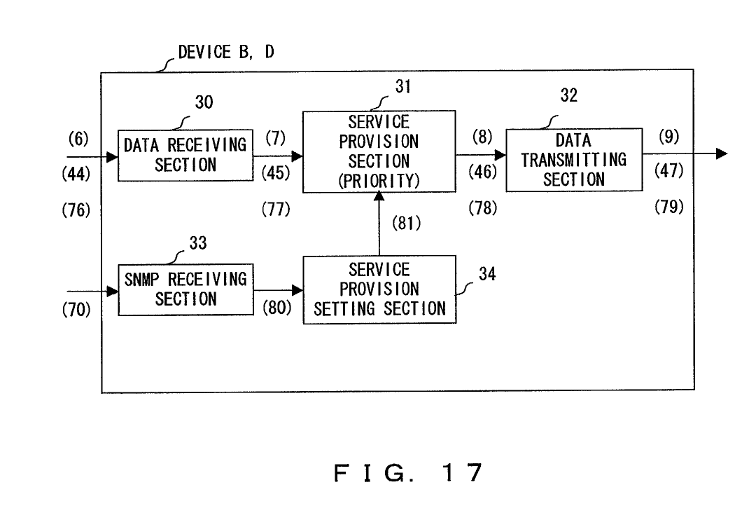

In FIGS. 15 through 17, the same reference numbers are attached to the same constituent components of each of the configurations as those shown in FIGS. 7 through 9. FIG. 15 shows the configuration of each of devices A and E. FIG. 16 shows the configuration device C. FIG. 17 shows the configuration of each of devices B and D.

The sequence of this preferred embodiment is described below with reference to FIGS. 15 through 18.

First, server S transmits a path message (RSVP) to device E. On receipt of the path message (1), device E transmits the message to an RSVP message processing section 43 (2). The RSVP message processing section 43 stores the routing information of the path message in a routing storage section 46 (3) and transmits the path message to a data transmitting section 45 through a service provision executing section 44 (4) and (5). The data transmitting section 45 transmits the path message to device D (6). Although device D receives the path message (6), device D transmits the path message to device A without processing the RSVP message (7), (8), and (9). On receipt of the path message in a data receiving section 42 (9), device A transmits the message to the RSVP message processing section 43 (10). The RSVP message processing section 43 stores the routing information of the path message in a routing storing section 46 (11) and transmits the path message to the data transmitting section 45 through the service provision executing section 44 (12) and (13). The data transmitting section 45 transmits the path message to host a (14).

On receipt of the path message, host a transmits a Resv message to server S in order to receive a band reservation service. In this case, for example, the user name and band to be reserved of a band reservation request is Kurose and 5 Mbps, respectively.

Device A receives the Resv message from host a (15) and notifies the RSVP message processing section 43 of the Resv message (16). On receipt of the Resv message, the RSVP message processing section 43 transmits a service provision availability request from a service provision availability requesting section 47 to device C using a COPS transmitting section 48 (17), (18), and (19). The transmitting data include transmitting/receiving addresses (S and a), user name, Kurose, and requested band, 5 Mbps.

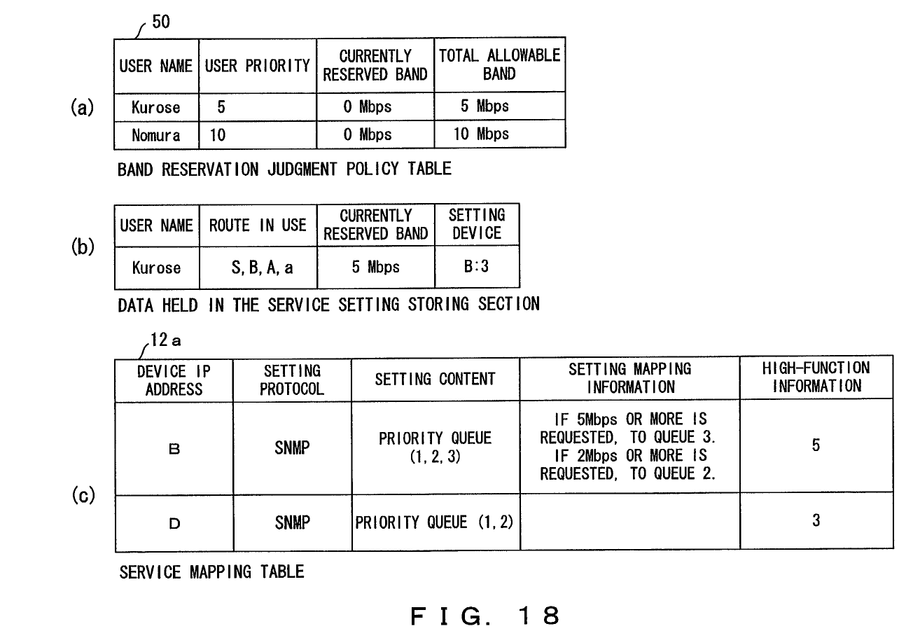

Device C receives a service provision availability request from device A in the COPS receiving section 11a of a network information collecting section 11 (19) and transmits the request to a band reservation permission judging section 51. The band reservation permission judging section 51 judges whether the service provision availability request can be accepted. The band reservation permission judging section 51 obtains the data of a band reservation judgment policy table 50 (FIG. 18(a))(21) and (22) and judges whether a service for requested band, 5 Mbps should be provided to user name, Kurose, based on the data. As a result, since according to the band reservation judgment policy table 50, the maximum band 5 Mbps is permitted to user name, Kurose and the current band in use is 0 Mbps, it is judged that this service should be provided. However, the availability judgment reply is returned to device A using COPS after obtaining the result of a route comparison section 61.

In this example, since this service is judged to be provided, the band reservation permission judging section 51 transmits the IP address A of device A that has transmitted both the transmitting/receiving IP addresses (S and a) and data, to both a setting device determining section 10 and a priority route selecting section 60, and transmits the transmitting/receiving IP addresses (S and a), user name, Kurose, and requested band, 5 Mbps, to the service mapping section 12 (23).

The priority route selecting section 60 obtains the IP address information of a higher-function or higher-performance device (in this preferred embodiment, device B has higher-performance) from both the data transmitted from the band reservation permission judging section 51 and the information of the routing information table 10a of the setting device determining section 10 and of the service mapping table 12a of the service mapping section 12 (23), (24), and (25), and judges that a priority relay route should consist of host a, device A, device B, device E and server S (a, A, B, E, and S) based on the IP address information and IP addresses (S, a, and A), routing information table 10a (topology information), and calculation using Dijkstra's algorithm, and transmits the priority routing information to a route comparison section 61 (26).

However, the setting device determining section 10 judges that a relay route should consist of host a, device A, device D, device E, and server S (a, A, D, E and S) based on the IP addresses (S, a, and A) obtained from the band reservation permission judging section 51, routing information table 10a (topology information) and setting device determining function section 10b (calculation using Djikstra's algorithm), and transmits the relay routing information to the route comparison section 61 (26).

On receipt of both the priority routing information and relay routing information from the priority routing selecting section 60 and setting device determining function section 10b, respectively, a route comparing section 61 compares (a, A, B, E, and S) with (a, A, D, E, and S), and as the comparison result, notifies the band reservation permission judging section 51 of information indicating that the two pieces of data are different (28). The band reservation permission judging section 51 also notifies the service mapping section 12 of information indicating that the priority route and specific relay route are different and the priority route is selected (29). The band reservation permission judging section 51 also requests a route setting generating section 62 to generate a setting for passing the data through a communication route of (a, A, B, E, and S) instead of (a, A, D, E, and S) (30).

The route setting generating section 62 obtains both the information from the route comparing section 61 and information about each device from the service mapping table 12a (31), and generates route setting information for passing communications data through the priority route. In this case, the route setting generating section 62 generates both a setting for setting data to device B if a transmitter address and a receiver address are a and S, respectively, for device A, and a setting for transmitting data to device B if a transmitter address and a receiver address are S and a, respectively, for device E and transmits the settings to the service mapping section 12 (32). The service mapping function section 12b of the service mapping section 12 transmits only route setting information received from the route setting generating section 62 to a device setting section 13a as service setting information (33). The device setting section 13a transmits a service setting request to an SNMP transmitting section 13b based on the service setting information from the service mapping section 12 (34). The SNMP transmitting section 13b transmits the setting content of the service setting request to each device as a service setting request (35). In this example, the service setting request is transmitted to devices A and E. The device setting section 13a also reflects the routing information modification setting in the routing information table 10a (36).

The band reservation permission judging section 51 detects the modification in the communication route based on both the band reservation judgment policy table 50 and route setting information from the route comparing section 61, and transmits judging information indicating the unavailability of service provision to a COPS transmitting section 13c (37). Thus, the COPS transmitting section 13c transmits information indicating the unavailability of service provision to device A (38).

On receipt of the service setting request of routing setting modification information in an SNMP receiving section 45, devices A and E immediately modify the routing information (36) and (37). Thus, data from server S pass through a route of server S, device E, device B, device A, and host a.

Then, server S transmits a path message (RSVP) to device E (80). On receipt of the path message in a data receiving section 42 (39), device E transmits the message to an RSVP message processing section 43 (40), stores the routing information of the path message in a route storing section 46 (41), transmits the path message to a data transmitting section 45 through a service provision executing section 44 (42) and (43) and transmits the path message to device B (44).

Although device B receives the path message (44), device B transmits the path message to device A without performing any processing (45), (46), and (47).

Device A receives the path message in a receiving section 42 (47), stores the routing information of the path message in the route storing section 46 (49) and transmits the path message to the data transmitting section 45 through the service provision executing section 44 (50) and (51). The data transmitting section 45 transmits the path message to host a (52).

On receipt of the path message, host a re-transmits a Resv message to server S in order to receive a band reservation service (53). In this example, the user name and reservation band of a band reservation request is Kurose and 5 Mbps, respectively. Device A receives the Resv message in the data receiving section 42 (53), and the data receiving section 42 notifies the RSVP message processing section 43 of the Resv message (54). On receipt of the Resv message, the RSVP message processing section 43 transmits a service provision availability request to device C from a COPS transmitting section 48 through a service provision availability requesting section 47 (55), (56), and (57). The transmitting data include the transmitting/receiving IP addresses (S and a), user name, Kurose, and requested band, 5 Mbps.

Device C receives the transmitting data from device A in the COPS receiving section 11a of a network information collecting section 11 (57), transmits the data to a band reservation permission judging section 51 (58) and judges the service provision availability. The band reservation permission judging section 51 obtains the data of the band reservation judgment policy table (FIG. 18(a)) (59) and (60) judges whether a service for the requested band, 5 Mbps, should be provided to user name, Kurose. Since the maximum band, 5 Mbps, is permitted for user name, Kurose, and the current band in use is 0 Mbps, device C judges that this service should be provided. However, the availability reply is returned using COPS after the result of the route comparing section 61 is obtained.

Since in this example, it is judged that the service should be provided, the band reservation permission judging section 51 transmits both the transmitting/receiving IP addresses (S and a) and the IP address A of device A that has transmitted the data, to both the setting device determining section 10 and priority route selection section 60 and transmits the transmitting/receiving IP addresses (S and a), user name, Kurose, and requested band, 5 Mbps, to the service mapping section 12 (61).

The priority route selecting section 60 obtains the IP address information of a higher-function or higher-performance device (in this preferred embodiment, device B has higher performance than device D) from both the routing information table 10a of the setting device determining section 10 and the service mapping table 12a of the service mapping section 12 (62) and (63), judges that the priority relay route should consist of host a, device A, device B, device E, and server S (a, A, B, E, and S) based on the address information and IP addresses (S, a, and A), routing information table 10a (topology information), and calculation using Dijkstra's algorithm, and transmits the priority routing information to the route comparing section 61 (64).

The setting device determining section 10 judges that the relay route should consist of host a, device A, device B, device E, and server S (a, A, B, E, and S), based on the IP addresses (S, a and A) obtained from the band reservation permission judging section 51, routing information table 10a (topology information) updated by the device setting section 13a and, setting device determining function section 10b (calculated using Dijkstra's algorithm), and transmits the routing information to the route comparing section 61 (65). On receipt of the two pieces of routing information obtained from both the priority route selecting section 60 and setting device determining function section 10b, the route comparing section 61 compares the two pieces of routing information (a, A, B, E, and S) and (a, A, B, E, and S), and notifies the band reservation permission judging section 51 of information indicating that the results are the same (66) The route comparing section 61 also notifies the service mapping section 12 of information indicating that the priority route and specified relay route are the same and that the priority route is selected (67). The service mapping function section 12b of the service mapping section 12 specifies device B as a relay router to be set based on the notified information, and obtains information indicating that the service can be set using an SNMP protocol and that if the requested band is 5 Mbps or more, the service is set in a queue with queue number 3, from the service mapping table 12a (FIG. 18C). Then, the service mapping function section 12b generates setting information indicating that communications between the transmitting/receiving IP addresses (S and a) should be conducted in a high-priority queue with queue number 3 as service setting information for a device with IP address B, and transmits the information to the device setting section 13a (68).

The device setting section 13a receives the service setting information from the service mapping section 12 (68), generates service setting request information for SNMP based on this service setting information and transmits this setting information to the SNMP transmitting section 13b (69). The SNMP transmitting section 13b transmits the service setting request information to device B, which is the setting target, based on the service setting request information from the device setting section 13a (70).

On receipt of the information from the route comparing section 61, the band reservation permission judging section 51 transmits service provision permission information to device A through the COPS transmitting section 13c (72).

Device A receives the service provision permission information in a COPS receiving section 40 (72), sets the service provision executing section 44 using a service provision setting section 41 (74) based on the service setting request received by the data transmitting section 45 (70) and starts to provide host a with the service. Device A transmits a Resv message to device B through the data transmitting section 45 (75) and (76).

On receipt of the Resv message in a data receiving section 30 (76), device B transmits the Resv message to device E without performing any processing since device B cannot process the RSVP message (77), (78), and (79).

On receipt of the service setting request information from device C in the SNMP receiving section 33 (70), device B transmits the information to the service provision setting section 34 (80) and the service provision setting section 34 makes a setting for providing a communications service between the transmitting/receiving IP addresses (S and a), in the service providing section 31 (81). As a result, in device B, a queue with queue number 3, which is a high-priority queue, is used for the communications between the transmitting/receiving IP addresses (S and a), and service provision to host a is started. Then, device E also starts service provision to host a like device A. Since in this case, the process content of device E is the same as that of device A in this preferred embodiment described above, the description is omitted.

Although a configuration in which device C obtains the dynamic state of the entire network is not described, the setting device determining section 10 is provided with a dynamic network information table 10c, as shown in FIG. 16, obtains network information from a network information collecting section 11 in real time, converts this information into a table and stores the information in a dynamic network information table 10c. Thus, by reflecting the data of the dynamic network information table 10c in the routing information table 10a, a priority route matching the current situation of the network can be selected.

FIG. 18 shows the tables of device C in the second preferred embodiment.

FIGS. 18(a), 18(b), and 18(c) show one band reservation judgment policy table 50, data stored in a service setting storing section, which is not shown in FIG. 16, and one service mapping table 12a, respectively.

FIG. 18(a) is the same table as that in the first preferred embodiment, and the table stores a user name, user priority, a currently reserved band and a total allowable band. In FIG. 18(b), a user name, a route in use, a currently reserved band, and a setting device are set. In this example, the table shows that the user name, communications route, and band to be reserved are Kurose, (S, B, A, and a) and 5 Mbps, respectively, and that a queue with queue number 3 is set for device B. The service mapping table 12a shown in FIG. 18(c) stores a high-function degree for indicating the height of the function of each device in addition to a device address, a setting protocol, a setting content and mapping information. When the priority route selecting section 60 determines a priority route, the priority route selecting section 60 specifies a route, including a higher-function device, by referring to this high-function degree.

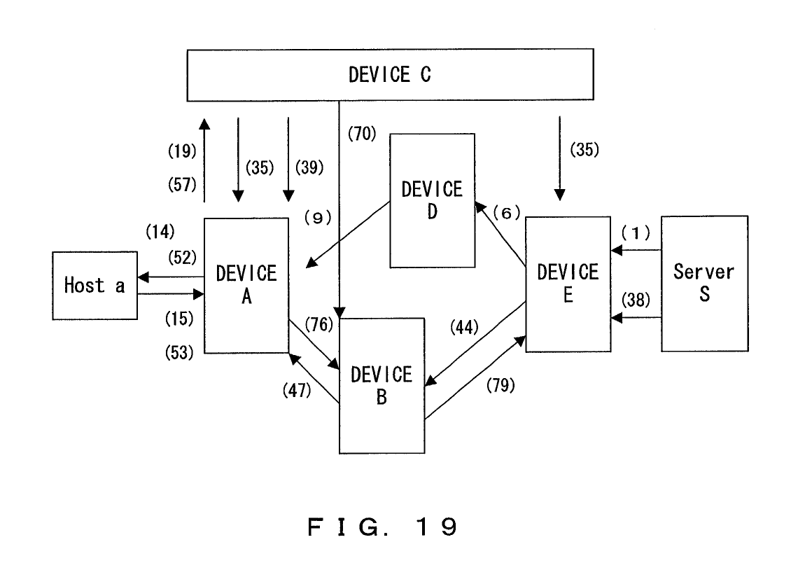

FIG. 19 shows the comprehensive network configuration of the second preferred embodiment.

In FIG. 19, parenthesized figures shown together with an arrow mark correspond to the reference numbers described with reference to FIGS. 15 through 18.

If in FIG. 19, of two routes connecting host a and server S, the current communications route passes through device D, information indicating that device B has a higher function than device D is obtained from the service mapping table 12a and a route, including device B, is selected as a priority route. Thus, when a new service request is received from host a, a route for providing a better service can be provided, and serviceability can be improved accordingly.

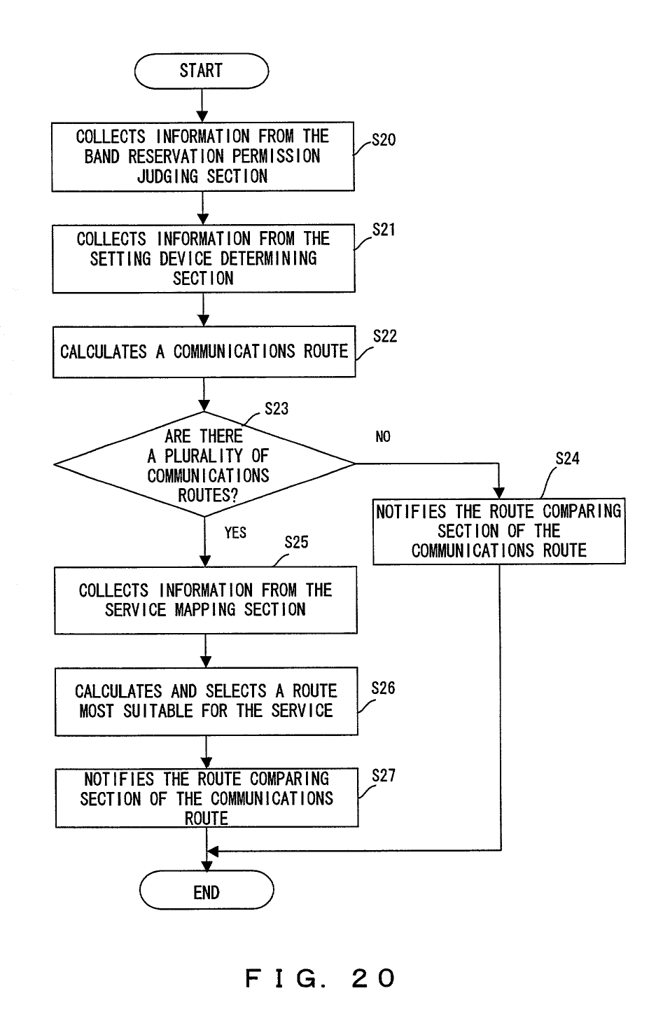

FIG. 20 is a flowchart showing the process flow of the priority route selecting section 60 in the second preferred embodiment.

First, in step S20, the priority route selecting section 60 collects information from the band reservation permission judging section 51. Then, in step S21, the section 60 collects information from the setting device determining section 10. Then, in step S22, the section 60 calculates a communications route for providing a service, based on the two pieces of information. In step S23, it is judged whether there are a plurality of communications routes. If there is only one route, in step S24, the section 60 notifies the route comparing section 61 of the communications route. If there are a plurality of communications routes, in step S25, the section 60 collects information from the service mapping section 12, and calculates/selects the best route of the service (step S26). If the best communications route is selected thus, in step S27, the section 60 notifies the route comparing section 61 of the communications route.

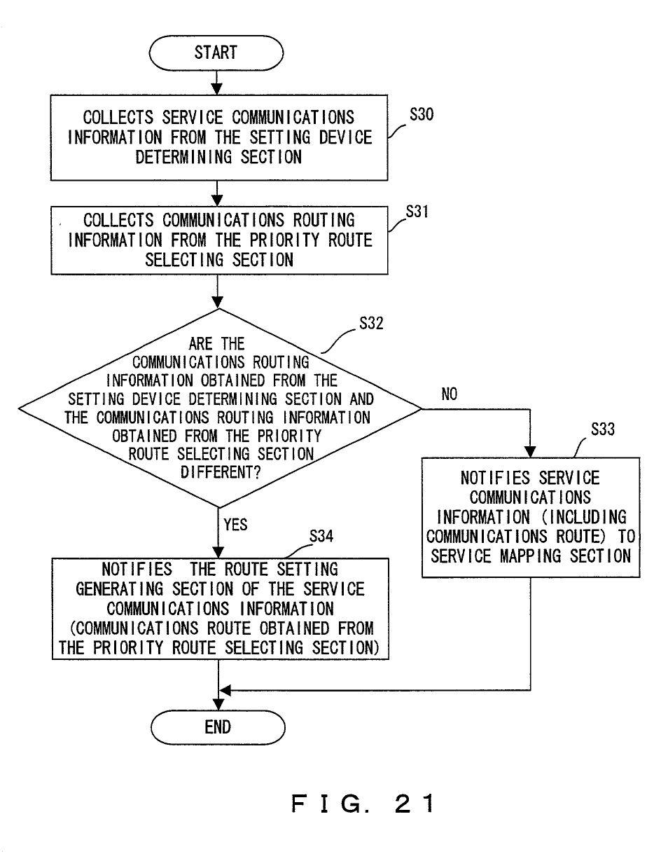

FIG. 21 is a flowchart showing the process flow of the route comparing section in the second preferred embodiment.

First, in step S30, the route comparing section 61 collects service communications information from the setting device determining section 10 and in step S31 the section 61 collects communications routing information from the priority route selecting section 60. Then, the section 61 judges whether the communications routing information obtained from the setting device determining section 10 and the communications routing information obtained from the priority route selecting section 60 are different. If the two pieces of communications routing information are the same, in step S33, the section 61 notifies the service mapping section 12 of the service communications information, including communications routing information. If in step S32 the two pieces of communications routing information are different, the section 61 notifies a route setting generating section 62 of the service communications information, including communications route obtained from the priority route selecting section 60 (step S34).

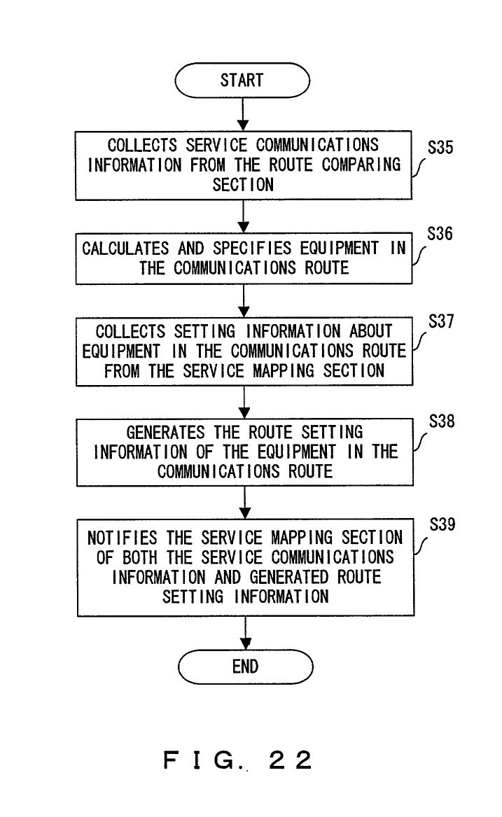

FIG. 22 is a flowchart showing the process flow of the route setting generating section 62 in the second preferred embodiment.

First, in step S35, the route setting generation section 62 collects the service communications information from the route comparing section 61, and in step S36, the section 62 calculates and specifies equipment in the communication route. Then, in step S37, the section 62 collects setting information about equipment in the communications route from the service mapping section 12, and in step S38, generates the route setting information of the equipment in the communications route. Then, in step S39, the section 62 notifies the service mapping section 12 of both the service communications information and generated route setting information.

Although in the second preferred embodiment described above, a router in the communications route between a host and a server is detected using OSPF, both topology and an IP communications route can be detected using another routing protocol, such as RIP and the like, or a network management protocol, such as SNMP and the like, can be used.

Although a route, including a high-performance device is also selected as the criteria for route selection, the route can also be selected based on whether the traffic of a route is heavy, based on information obtained using a network management protocol.

Furthermore, although device C uses SNMP for a protocol for transmitting an external setting, a Telnet protocol, COPS, CLI and the like can also be used.

Although network data (user information, device information, etc.) are stored in device C, the data can also be stored in a device other than device C and device C can also obtain the data from the device, as requested.

Although in the second preferred embodiment described above, a setting is made in a device corresponding to device B in a relay route, the setting can also be made in only a predetermined router or a service provision setting can also be made in the switch device in an MAC layer other than a relay router in the route (layer 2 switch, etc.), a layer 3 switch, an ATM switch and the like.

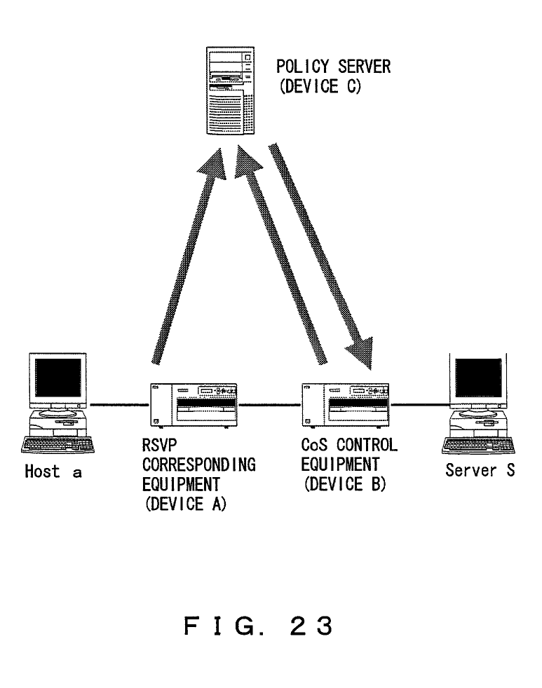

FIG. 23 shows one configuration of the third preferred embodiment corresponding to the third aspect of the present invention.

In this preferred embodiment, if a service is provided to host a after host a requests a service (reservation request: RSVP), the policy server (device C) detects the completion of the service request, and makes CoS-controllable equipment (device B) cancel or modify the setting of host a. As a result, in this preferred embodiment, a network in which a resource is not pointlessly provided after a service request is terminated can be configured.

The network of this preferred embodiment comprises host a, server S, device A, device B, and device C. The devices are connected to each device by a data transmission medium.

In this preferred embodiment, host a is an end terminal, such as a personal computer and the like for receiving both QoS and CoS control services. This host a is connected to a network, and can receive a path message (RSVP) outputted by server S, which is described later, transmit a Resv message (RSVP) and make a service request to the network. The policy server (device C) stores both information about a user using the terminal and the IP address information of the terminal in order to use the two pieces of information in the processing section of the policy server. In this preferred embodiment, the IP address of host a is a.

In this preferred embodiment, server S has a function to transmit data to an end terminal as an application server. This server S is also connected to the network, and can transmit a path message (RSVP) and receive the Resv message (RSVP). The policy server (device C) stores both the application information and IP address information of server S in order to use the two pieces of information in the processing section of the policy server. In this preferred embodiment, the IP address of server S is S.

Device A is an RSVP responding router. Device A can receive/process an RSVP message, and provide a service. On receipt of a service request, device A makes a request for service provision availability judgment to the policy server (device C) using COPS and follows the availability judgment reply. Device A also has a band-reservable queue (data communications buffer), and the queue number of a queue for reserving a band of 10 Mbps and the queue number of a queue for reserving a band of 5 Mbps are 2 and 1, respectively. The IP address of device A is A. Device A also can transmit the setting content of the device outside from the SNMP transmitting section.

Device B is an RSVP non-responding Cos-controllable router, and the CoS control setting of device B can be made from outside. Since device B cannot process an RSVP message, device B passes the RSVP message through device B without performing any processing. Device B has three queues with different priorities (high-priority, middle-priority and low-priority), and the queue numbers are 3, 2, and 1, respectively. The IP address is B.

Device C is a service allocating device (policy device). Device C can receive a service provision availability request using COPS from network equipment, judge the availability based on a band reservation judgment table stored in device C and return the judgment result using COPS. In response to the COPS request, device C can obtain the IP addresses of both a host that requests a service and a communicating server, a user name, a requested band value and the like, and can use the plurality of information for the calculation and operation in device C.

By obtaining transmitter/receiver IP addresses, device C specifies a router for relaying generated transmitting/receiving data using the setting device determining section. The processing section of device C can receive an OSPF LSA packet broadcast to a network if the network uses OSPF as an IP routing protocol. Specifically, since the LSA packet includes the topology information of a router, on receipt of this packet, device C can obtain the topology (store the topology as a routing information table) and calculate the shortest path based on the transmitting/receiving IP addresses using Dijkstra's algorithm. As a result, device C can calculate an IP path and specify a relay router.

Device C can also obtain the current setting state using the IP address of a relay router specified by both the dynamic network information table and information from the service setting storing section. The setting state includes a settable parameter, an already set parameter, a protocol used for setting, a setting method, and the like. Furthermore, device C can generate a setting value peculiar to each relay router in the service mapping table or service mapping section, based on both the setting state information of a relay router and the transmitting/receiving IP addresses, user name and requested band value that are obtained using COPS. Device C transmits a generated setting to each relay router using SNMP to reflect the setting in each relay router. Thus, a setting meeting a service request can be made in device B that cannot provide a service although there is a service request in a network.

If such a device C is provided, by performing a process in the service competition calculating section using the data of both the band reservation judgment policy table and service setting storing section, a proper judgment can be made against a competing service request in a network and an adjusted service setting can be generated. Therefore, an appropriate service can be provided throughout the network.

Furthermore, device C can release network resources related to service provision to be terminated by either canceling the service setting of a device that provides the service to be terminated or resetting other settings than the service setting from the beginning using both the service stoppage request generating section for processing the termination of the service request as a service request for providing no service and the service setting storing section for storing previous services. Alternatively, the service competition calculating section can calculate the influence on other services due to the termination of a specific service, and a new service setting or a service modification can be made against a network.

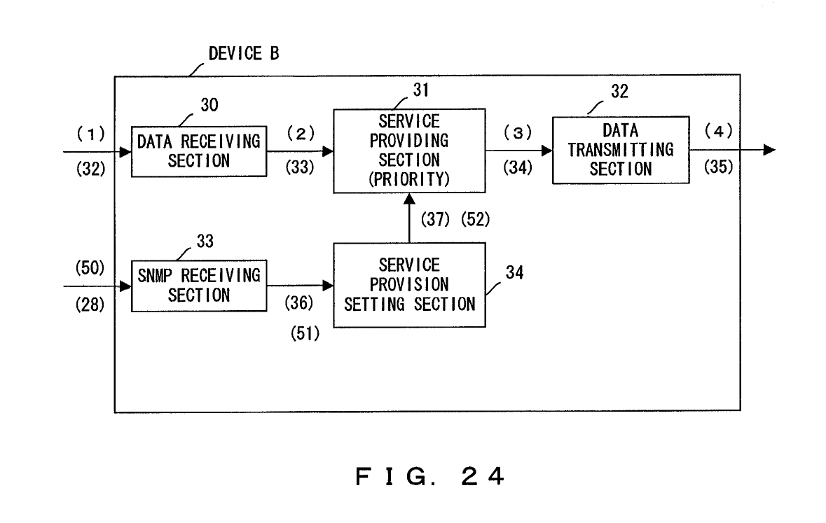

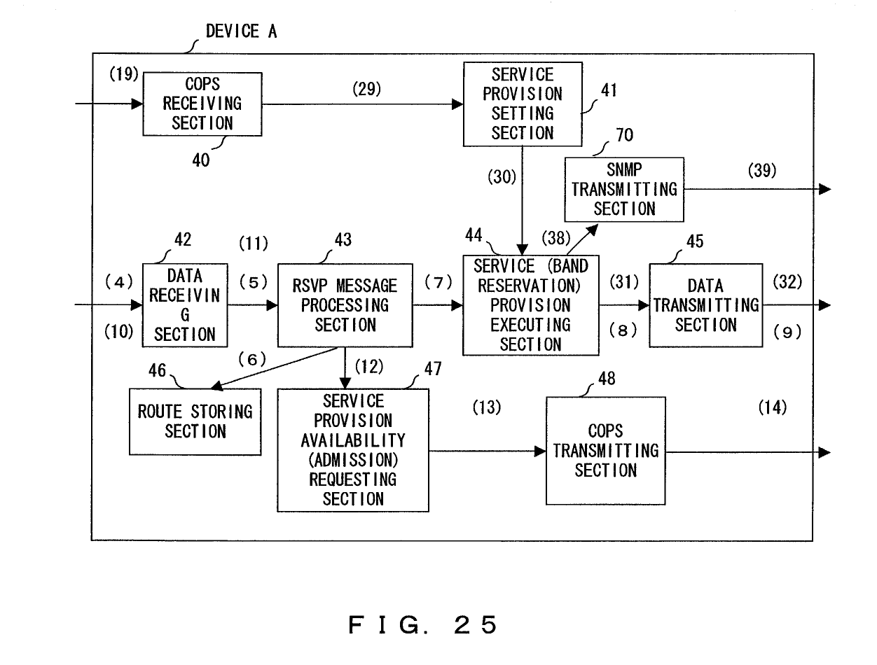

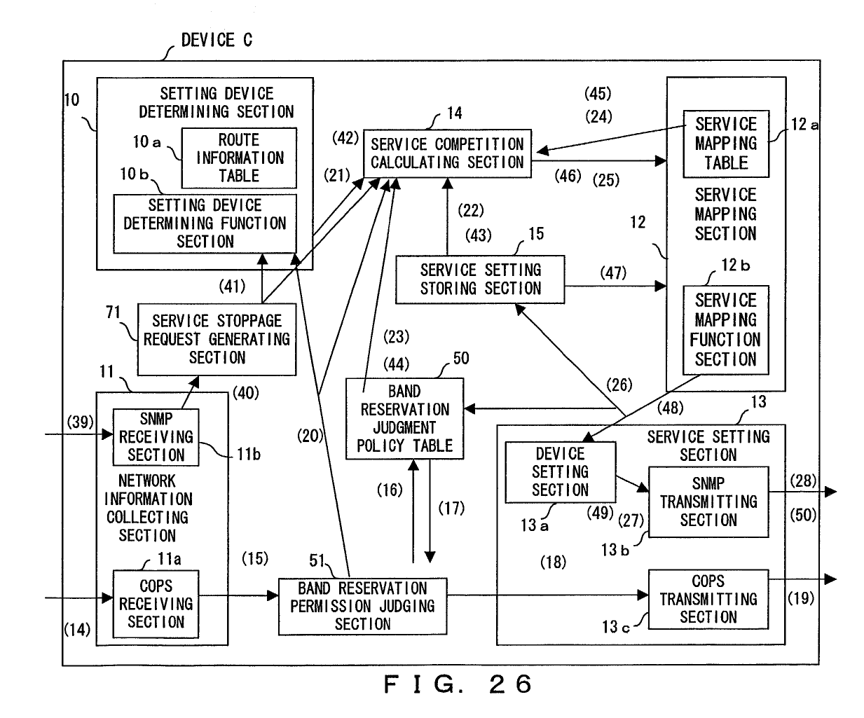

FIGS. 24 through 26 show the configuration and process flow of each device in the third preferred embodiment.

FIGS. 24, 25, and 26 show the configurations of devices B, A, and C, respectively.

In FIGS. 24 through 26, the same reference numbers are attached to the same constituent components as those shown in FIGS. 7 through 9.

First, server S transmits a path message (RSVP) (1) to device B. Although device B receives the path message (1), device B transmits the path message to device A without performing any process against the RSVP message (2), (3), and (4).

On receipt of the path message (4), device A transmits the message to the RSVP message processing section 43 (5), stores the routing information of the path message in the route storing section 46 (6), transmits the path message to the data transmitting section 45 through the service provision executing section 44 (7) and (8) and transmits the path message to host a (9).

On receipt of the path message, host a transmits a Resv message to server S in order to receive a band reservation service. For example, the user name and band to be reserved of a band reservation request are Kurose and 5 Mbps, respectively.

On receipt of the Resv message (10), device A notifies the RSVP message processing section 43 of the message (11). The RSVP message processing section 43 transmits a service provision availability request to device C from a service provision availability request generating section 47 using a COPS transmitting section 48 (12), (13), and (14). The transmitting data includes transmitting/receiving IP addresses (S and a), user name, Kurose, and requested band, 5 Mbps.

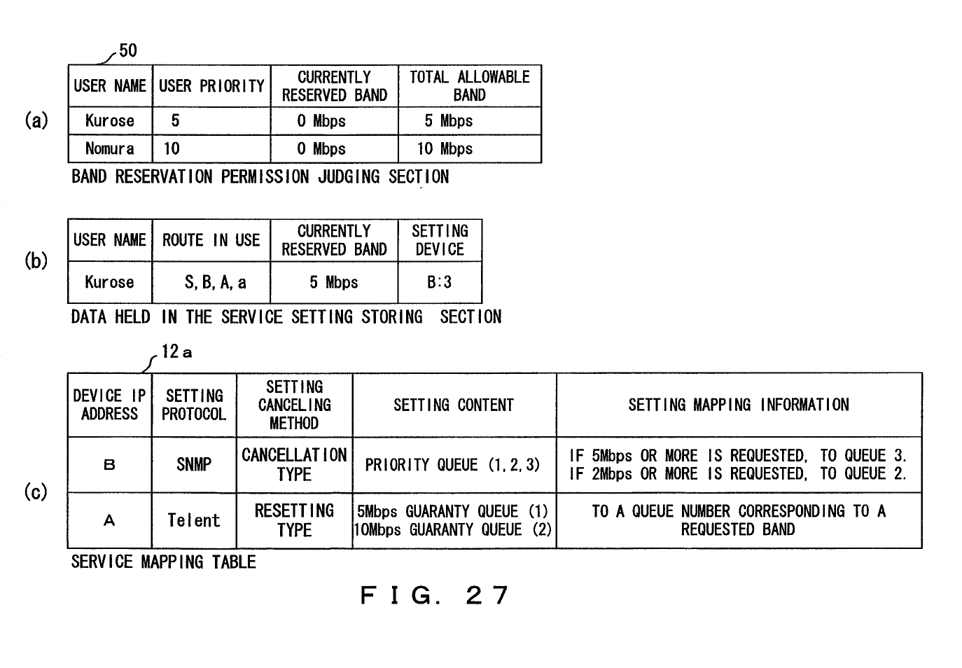

Device C receives the transmitting data from device A in the COPS receiving section 11a (14), transmits the data to the band reservation permission judging section 51 (15) and judges whether the service should be provided. The band reservation permission judging section 51 obtains data from the band reservation judgment policy table 50 (FIG. 27(a)) (16) and (17), and judges whether requested band, 5 Mbps, should be permitted for user name, Kurose. As a result, since according to the band reservation judgment policy table 50, the maximum 5 Mbps is permitted in advance for user name, Kurose, and the current band in use, 0 Mbps, this service is judged to be provided.

The permission result is transmitted to a COPS transmitting section 13c (18), and the COPS transmitting section 13c transmits service provision availability judgment information to device A (19). Since in this example, the service is judged to be provided, the band reservation permission judging section 51 transmits both the transmitting/receiving IP addresses (S and a) and the IP address A of device A that has transmitted the data to the setting device determining section 10 and transmits the transmitting/receiving IP addresses (S and a), user name, Kurose, and requested band, 5 Mbps, to the service competition calculating section 14 (20).

The setting device determining section 10 judges that the relay route should consist of host a, device A, device B, and server S (a, A, B, and S) based on the IP address (S, a, and A) obtained from the band reservation permission judging section 51, routing information table (topology information) and setting device determining function section 10b (calculated using Dijkstra's algorithm), and transmits the routing information to the service competition calculating section 14 (21).

The service competition calculating section 14 checks whether a service is currently provided in the relay route, based on the relay routing information obtained from the setting device determining function section 10b. For the confirmation information, the information of the service setting storing section 15 is used (22). Both the band reservation judgment policy table 50 and service mapping table 12a are also referenced as requested (23) and (24). In this preferred embodiment, it is assumed that no service is currently provided in route (S, B, A, and a). Thus, the service competition calculating section 14 transmits user name, Kurose, requested band, 5 Mbps, and route in use (S, B, A, and a) to the service mapping section 12 as service competition result information without performing any processing (25).

The service mapping section 12 specifies device B as a relay router to be set, based on the service competition result information, obtains from the service mapping table 12a (FIG. 27(c)) information indicating that the service can be set using an SNMP protocol and that request band, 5 Mbps or more, should be set in a queue with queue number 3, and generates service setting information for conducting communications between transmitting/receiving IP addresses (S and a) in a high-priority queue with queue number 3 for a device with IP address B. The service mapping section 12 also transmits the generated service setting information to the service setting storing section 15, band reservation judgment policy table 50, and device setting section 13a (26). Both the service setting storing section 15 and band reservation judgment policy table 50 modify stored data based on the service setting information received from the service mapping section 12.

The device setting section 13a generates service setting information for SNMP based on the service setting information received from the service mapping section 12 and transmits the service setting information to the SNMP transmitting section 13b (27). The SNMP transmitting section 13b transmits service setting request information to device B, which is the setting target, using SNMP based on the receiving information from the device setting section 13a (28).

On receipt of the service provision permission information in the COPS receiving section 40 (19), device A sets the service provision executing section 44 using the service provision setting section 41 (29) and (30) and starts to provide host a with the service. Device A also transmits a Resv message to device B (31) and (32).

On receipt of the Resv message (32), device B transmits the Resv message to server S without performing any processing since device B cannot process an RSVP message (33), (34), and (35). When device B receives the service setting request from device C (28), the service provision setting section 34 makes a setting for conducting communications between transmitting/receiving IP addresses (S and a) in a queue with queue number 3 in the service providing section 31, based on the provision setting information (36) and (37). As a result, in device B, a high-priority queue with queue number 3 is used for the communications between the transmitting/receiving IP addresses (S and a), and the service provision is started.

Since device C monitors the service provision state information from device A by the SNMP receiving section 11b, if host a stops the service request or the service provision by device A is terminated for some reason, the SNMP transmitting section 70 of device A transmits the service provision state information (the transmitting/receiving IP addresses and queue number of the guaranteed communications) to device C (38), and notifies device C of the information (39). In this preferred embodiment, the transmitting/receiving IP addresses and queue number of the transmitting data are (a and S) and 1, respectively.

The SNMP receiving section 11b of device C transmits the received data to a service stoppage request generating section 71 (40). The service stoppage request generating section 71 notifies the setting device determining section 10 of both the transmitting/receiving IP addresses and the IP address of device A, and notifies the service competition calculating section 14 of both the queue number and service stoppage request information (41).

The setting device determining section 10 judges that the relay route should consist of host b, device A, device B, and server S (b, A, B, and S), based on the IP addresses (S, b, and A) obtained from the service stoppage request generating section 71, routing information table (topology information), and setting device determining function section 10b (calculated using Dijkstra's algorithm), and transmits the relay routing information to the service competition calculating section 14 (42).

The service competition calculating section 14 checks whether a service is currently provided in the route, based on the relay routing information obtained from the setting device determining section 10. For the confirmation information, the information of the service setting storing section 15 is used (43). Both the band reservation judging policy table 50 and service mapping table 12a are also referenced as requested (44) and (45). In this preferred embodiment, it is detected that in device B, user name, Kurose, is already provided with a high-priority queue for a 5 Mbps band reservation service. Then, since the service provision routes are the same, and according to the service mapping table 12a, a service provided to device A and a service to be set by device B are the same, the service competition calculating section 14 judges that a service provided to the transmitting/receiving IP addresses (a and S) in queue 3 of device B is a stoppage service at a service stoppage request and notifies the service mapping table 12a of the stoppage service information (46). Simultaneously, the service competition calculating section 14 refers to the service setting storing section 15, band reservation judgment policy table 50, and service mapping table 12a, as requested (44) and (45), and notifies the service mapping section 12 of another new service setting accompanying service termination or content modification information (46).

The service mapping function section 12b of the service mapping section 12 specifies device B as a relay router to be set, and since according to the service mapping table 12a (FIG. 27(c), a setting canceling method matching device B is of cancellation type (in this preferred embodiment, a method for stopping a service by the cancellation command of the service item), the section 12b generates service setting information for requesting device B with IP address B to cancel the setting for conducting communications between transmitting/receiving IP addresses (S and a) in a high-priority queue with queue number 3. If the method is not of cancellation type, both all the previous service settings, except for the setting to be cancelled (full data read from the service setting storing section 15 (47)) and the basic setting must be made in a target device. If there is other service setting information from the service competition calculating section 14, the service mapping function section 12b similarly generates the service setting information. The service mapping function section 12b of the service mapping section 12 transmits the generated service setting information to the service setting storing section 15, band reservation judgment policy table 50 and device setting section 13a (48). Both the service setting storing section 15 and band reservation judgment policy table 50 modify stored data based on the receiving information from the service mapping section 12.

The device setting section 13a generates service request information for SNMP based on the receiving information from the service mapping section 12 and transmits the information to the SNMP transmitting section 13b (49). The SNMP transmitting section 13b transmits a service setting request to device B, which is the setting target, using SNMP based on the information from the device setting section 13a (50).

When device B receives the service setting request for stopping the service provision from device C (50), the service provision setting section 34 deletes the setting information for conducting communications between transmitting/receiving IP addresses (S and a) using a queue with queue number 3 from the service providing section 31 (51) and (52). As a result, in device B, a high-priority queue with queue number 3 is prevented from being used for communications between transmitting/receiving IP addresses (S and b) and the service provision of the communications is stopped. If, simultaneously, there are other service setting requests, the settings are sequentially made after the stoppage of the service provision.

FIG. 27 shows the tables of device C in the third preferred embodiment.

FIGS. 27(a), 27(b) and 27(c) show one band reservation judgment policy table 50, data stored in the service setting storing section 15 and one service mapping table 12a, respectively.

As shown in FIG. 27(a), the band reservation judgment policy table 50 stores a user name, user priority, a currently reserved band and a total allowable band. In this example, as user names, both Kurose and Nomura are stored, and priority is given to Nomura. Each of the currently reserved bands is 0 Mbps and can receive a new service. As shown in FIG. 27(b), in this example, the service setting storing section 15 stores a user name, a route in use, a currently reserved band and a setting device, and stores information indicating that a 5 Mbps band service is provided to user name, Kurose using a communications route (S, B, A, and a). According to setting device information, device B does not respond to service requests, device B makes a special setting and queue 3 is allocated to device B. The service mapping table 12a shown in FIG. 27(c) stores a device IP address, a setting protocol, a setting canceling method, and setting mapping information.

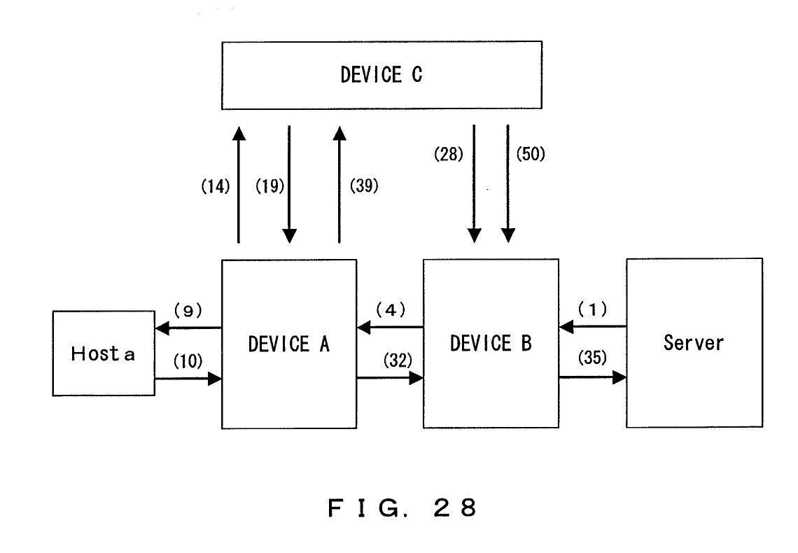

FIG. 28 shows the comprehensive configuration of the network in the third preferred embodiment.

The numbers shown in FIG. 28 correspond to the numbers described with reference to FIGS. 24 through 27. In this preferred embodiment, devices A and B that have provided a service upon a service request from host a can allocate an idle line released by a service stoppage request from host a to another service. Specifically, when device A, which is a service request responding device, detects a service stoppage request from host a and notifies device C of this detection information, the stoppage of the service provision to host a can be determined, and the setting accompanying the service stoppage can be reflected in the setting of the service request non-responding device B.

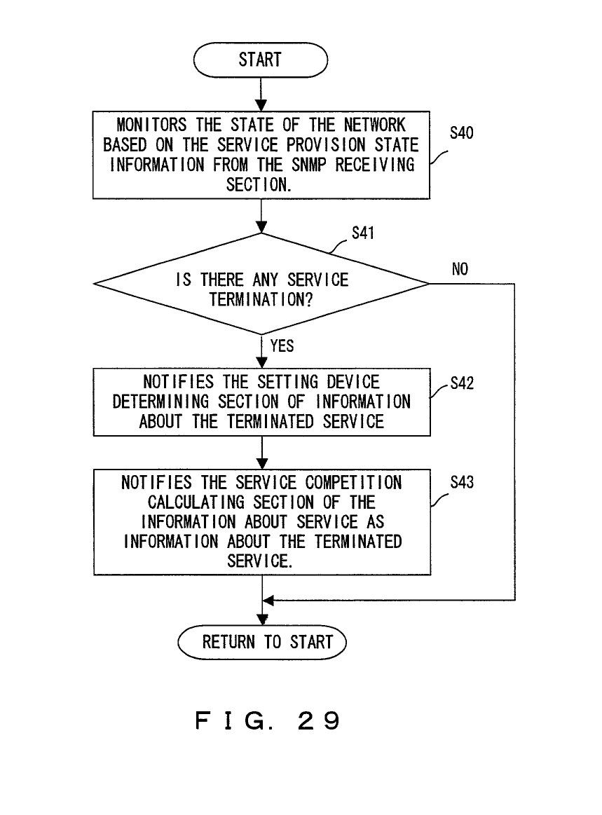

FIG. 29 is a flowchart showing the process flow of the service stoppage request generating section 71 in the third preferred embodiment.

First, in step S40, the service stoppage request generating section 71 monitors the state of the network using the service provision state information from the SNMP receiving section 11b. In step S41, the section 71 judges whether there is any service termination. If there is no termination, the process returns to the start. If it is judged that there is some service termination, in step S42, the section 71 notifies the setting device determining section 10 of information about the service and in step S43, the section 71 notifies the service competition calculating section 14 of the information about the service as the information about the terminated service. Then, the process returns to the start.

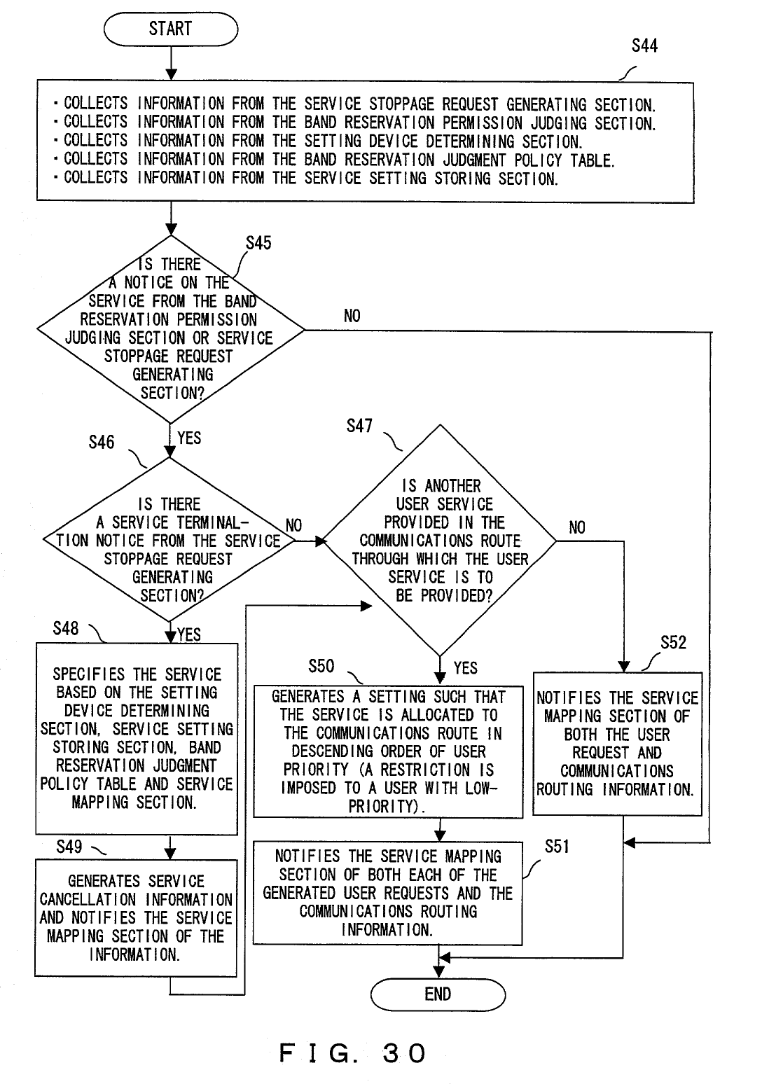

FIG. 30 is a flowchart showing the process flow of the service competition calculating section 14 in the third preferred embodiment.

First, in step S44, the service competition calculating section 14 collects information from each of the service stoppage request generating section 71, band reservation permission judging section 51, setting device determining section 10, band reservation judgment policy table 50, and service setting storing section 15. Then, in step S45, the section 14 judges whether there is a service notice from the band reservation permission judging section 51 or service stoppage request generating section 71. If there is no notice, the process is terminated. If there is a service notice, the process proceeds to step S46. In step S46, the section 14 judges whether there is a service terminating notice from the service stoppage request generating section. If there is a service stopping notice, in step S48, the section 14 specifies the service based on the plurality of information from the setting device determining section 10, service setting storing section 15, band reservation judgment policy table 50, and service mapping section 12. Then, in step S49, the section 14 generates service cancellation information, notifies the service mapping section 12 of the information, and terminates the process.

If in step S46 it is judged that there is no service terminating notice or if the section 14 receives the information generated in step S49, in step S47 the section 14 judges whether a service for another user is provided through the communications route through which the service for the notified user is to be provided If no service is provided, in step S52, the section 14 notifies the service mapping section of both the user request and communications routing information from the setting device determining function section 10b and terminates the process. If in step S47 it is judged that a service for another user is provided, in step S50, the section 14 generates communications route setting information for allocating services in descending order of user priority. Specifically, the section 14 imposes restrictions on low-priority users. Then, in step S51, the section 14 notifies the service mapping section 12 of both the generated user request and communications routing information, and terminates the process.

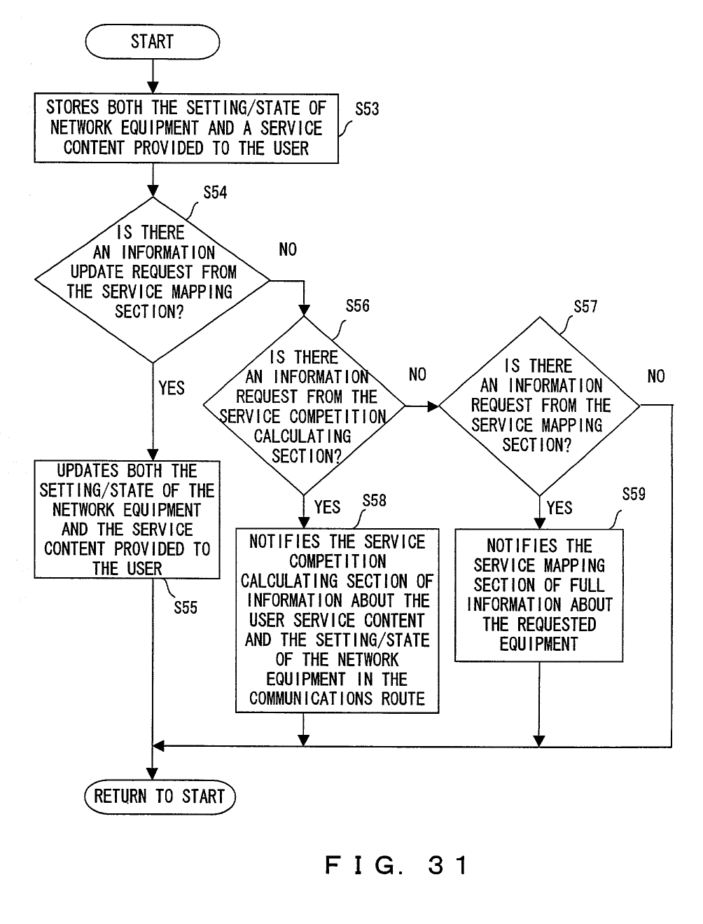

FIG. 31 is a flowchart showing the process flow of the service setting storing section 15 in the third preferred embodiment.

In step S53, the service setting storing section 15 stores both the setting/state of network equipment and service content provided to a user. In step S54, the section 15 judges whether there is an information update request from the service mapping section 12. If there is the information update request, in step S55, the section 15 updates both the setting/state of network equipment and service content provided to a user, and the process returns to the start.

If in step S54 there is no information request, in step S56, the section 15 judges whether there is an information request from the service competition calculating section 12. If there is an information request, in step S58 the section 15 notifies the service competition calculating section 14 of information about both the user service content and the setting/state of the network equipment in the communications route, and the process returns to the start.

If in step S56 there is no information request, in step S57, the section 15 judges whether there is an information update request from the service mapping section 12. If there is an information request, in step S59, the section 15 notifies the service mapping section 12 of the full information about requested equipment, and the process returns to the start. If in step S57 it is judged that there is no information request, the process returns to the start without performing any processing.

Although in the preferred embodiment described above, a router in the communications route between a host and a server is determined using OSPF, both topology and an IP communications route can also be determined using another routing protocol, such as RIP and the like, or using a network management protocol, such as SNMP, COPS, CLI, and the like.

Although service provision setting data are stored in device C, the data can also be stored in another device instead of device C and can be obtained as requested using a network management protocol, such as SNMP, a Telnet protocol, and the like. Although device C uses SNMP as an external setting transmitting protocol, a Telnet protocol can also be used.

Furthermore, device C stores network data (user information, device, device information, etc.), a device other than device C can store the data, and device C can obtain the data from the device, as requested.

Although in the preferred embodiments, a setting is made in a device corresponding to device B in a relay route, the setting can also be made in only a predetermined router, and a service provision setting can also be made in an MAC-layer switch device other than a relay router in the route (layer 2 switch, etc.), a layer 3 switch, an ATM switch, and the like.

In the preferred embodiments described above, a service stoppage or modification trigger for a service provision stoppage setting for device B, accompanying the service stoppage of device A can also be a change in a network, such as network congestion and the like. Furthermore, a device for modifying or canceling a setting can be any device if the device can be set from outside.

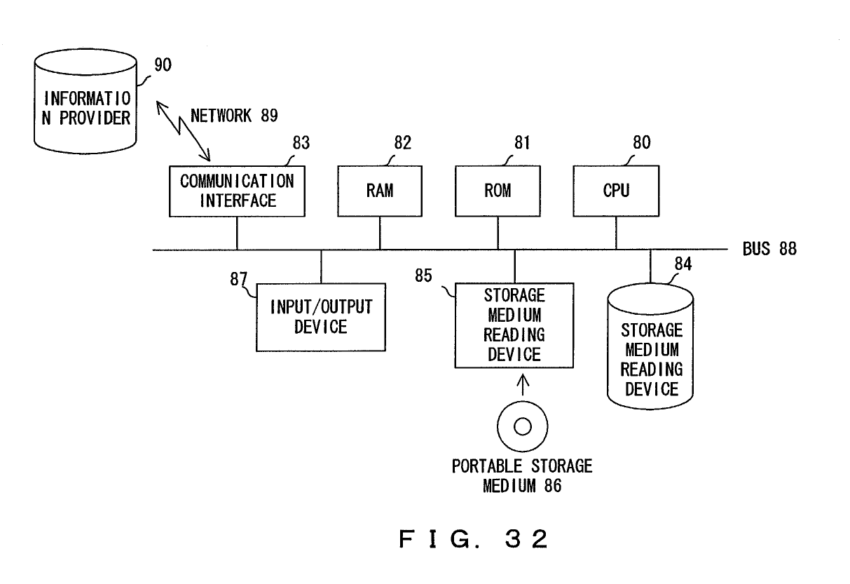

FIG. 32 shows a hardware environment needed by a program to implement the function of device C in each preferred embodiment of the present invention.

Although in the preferred embodiment, it is assumed that device C is configured by hardware, in reality a program can implement the entire operation.

A CPU 80 executes a program for implementing this preferred embodiment while transmitting/receiving data through a bus 88. The program is stored in a storage device, such as a hard disk, etc., or a portable storage medium, such as a floppy disk, a CD-ROM, an MO, etc. The program stored in the storage device 84 is directly loaded into a RAM 82 through the bus 88 and is executed by the CPU 80. The program stored in the portable storage medium 86 is read by a storage medium reading device 85 and is loaded into the RAM 82 through the bus 88. Then, the CPU 80 executes the program loaded into the RAM 82.

Alternatively, if the function of device C is implemented by firmware, a ROM 81 can store the program and the CPU 80 can execute the program while reading the program from the ROM 81 through the bus 88.

Both the acquisition of the execution situation of the program and the input of manager's commands can be performed by an input/output device 87 consisting of a keyboard, a mouse, a display, and the like.

Device C can also access an information provider 90 through a network 89 using a communications interface 83. In this case, the information provider 90 can store data needed to execute the program, such as tables and the like, and device C can also perform the process by downloading the data through the network, as requested. Alternatively, the information provider 90 can store the program, device C can transmit necessary information to the information provider 90 through the network 89, the information provider 90 can execute the program, and device C can receive only the execution result through the network 98.

Alternatively, device C can download the program from the information provider 90, device C can temporarily store the program in the storage device 84 and the like, and the CPU 80 can execute the program.

Furthermore, device C can also be connected to the information provider 90 through the network 89 using the communications interface 83 and can execute the program in a network environment.

Such a program can be distributed by storing the program in the portable storage medium 86.

According to the present invention, if a specific user makes a service request in a network where there are a service request responding device and a service request non-responding device, a setting for enabling the provision of the requested service can be made in the service request non-responding device in a communications route for providing a user with a service. Therefore, even in a network where there are a service request responding device and a service request non-responding device, an adequate service can be provided to a user.

What is claimed is:

1. A service allocating device in a network where at least one first device which responds to a network service request and at least one second device which does not respond to the network service request and a setting which can be modified from outside are connected, comprising:
a unit obtaining information about a network service provided by the first device;
a unit specifying the second device which does not respond to the network service; and
a unit converting a setting content of the network service received by the first device and requested for the first device, to a setting content to which the second device can respond, and setting the setting content obtained by the conversion in the second device; which
performs control of the setting content of the second device that does not correspond to the network service by the first device, according to the network service request received by the first device.

2.The service allocating device according to claim 1, further comprising:
a service setting storing unit storing setting contents of the first and second devices, which respond to previous network services; and
a service competition calculating unit checking a competition relation between network service requests from a plurality of users based on information stored in the service setting storing section, adjusting the competition relation, and determining the setting contents of the first and second devices so as to respond to the network service to be provided.

3. The service allocating device according to claim 1, further comprising:
a priority route selecting unit selecting a device for providing a higher function of a requested network service, of the first and second devices which are connected to the network, and determining a communications route through which the selected devices are connected; and
a route comparison unit comparing a communications route used prior to a new network service request with a communications route determined by the priority route selecting unit.

4. The service allocating device according to claim 3, further comprising
a route setting generating unit determining a communications route suitable for provision of the new network service based on a comparison result obtained by the route comparison section, which
performs control so that the new network service can be provided, using a communications route determined by the route setting generating unit.

5. The service allocating device according to claim 2, further comprising:
a service stoppage request generating unit obtaining information about a network service provision state of the first device, detecting provision stoppage of a network service by the first device based on the network service provision state information, and generating a service stoppage request;
a service setting storing unit storing a plurality of setting information of the first and second devices, which correspond to a network service that existed before provision stoppage of the network service is detected; and
a service competition calculating unit calculating a service competition relation that is modified by the detected provision stoppage of the network service according to both the service stoppage request and storage information of the service setting storing section.

6. A service allocating method in a network where at least one first device which responds to a network service request and at least one second device which does not respond to the network service request and a setting of which can be modified from outside are connected, comprising:
(a) obtaining information about a network service provided by the first device;
(b) specifying the second device which does not respond to the network service; and
(c) converting a setting content of the network service received by the first device and requested for the first device, to a setting content to which the second device can respond; and
(d) setting a setting content obtained by the conversion in the second device; which
performs control of the setting content of the second device that does not correspond to the network service by the first device, according to the network service request received by the first device.

7. The service allocating method according to claim 6, further comprising:
(e) storing setting contents of the first and second devices, which respond to previous network services; and
(f) checking a competition relation between network service requests from a plurality of users based on storage information in step (e), adjusting the competition relation and determining the setting contents of the first and second devices so as to respond to a network service to be provided.

8. The service allocating method according to claim 6, further comprising:
(g) selecting a device for providing a higher function of a requested network service, of the first and second devices which are connected to the network, and determining a communications route through which the selected devices are connected; and
(h) comparing a communications route used prior to a new network service request with a communications route determined by the priority route selecting section.

9. The service allocating method according to claim 8, further comprising:
(i) determining a communications route suitable for provision of the new network service based on a comparison result obtained by the route comparing section, which
performs control so that the new network service can be provided, using a communications route determined in step (i).

10. The service allocating method according to claim 7, further comprising:
(j) obtaining information about a network service provision state of the first device, detecting provision stoppage of a network service by the first device based on the network service provision state information and generating a service stoppage request;
(k) storing a plurality of setting information of the first and second devices, which correspond to a network service existed that before provision stoppage of the network service is detected; and
(l) calculating a service competition relation that is modified by the detected provision stoppage of the network service according to both the service stoppage request and the information stored in step (e).

11. A computer-readable storage medium which stores a program for enabling a computer to execute a service allocating process in a network where at least one first device which responds to a network service request and at least one second device which does not respond to the network service request and the setting of which can be modified from outside are connected, the process comprising:
(a) obtaining information about a network service provided by the first device;
(b) specifying the second device which does not respond to the network service; and
(c) converting a setting content of the network service received by the first device and requested for the first device to a setting content to which the second device can respond; and
(d) setting a setting content obtained by the conversion in the second device; which
performs control of the setting content of the second device that does not correspond to the network service by the first device, according to the network service request received by the first device.

12. The storage medium according to claim 11, the process further comprising:
(e) storing setting contents of the first and second devices, which respond to previous network services; and
(f) checking a competition relation between network service requests from a plurality of users based on information stored in step (e), adjusting the competition relation, and determining the setting contents of the first and second devices so as to respond to a network service to be provided.

13. The storage medium according to claim 11, the process further comprising:
(g) selecting a device for providing a higher function of a requested network service, of the first and second devices which are connected to the network, and determining a communications route through which the selected devices are connected; and
(h) comparing a communications route used prior to a new network service request with a communications route determined by the priority route selecting section.

14. The storage medium according to claim 13, the process further comprising:
(i) determining a communications route suitable for provision of the new network service based on a comparison result obtained by the route comparing section, which
performs control so that the new network service can be provided, using a communications route determined in step (i).

15. The storage medium according to claim 12, the process further comprising:
(j) obtaining information about a network service provision state of the first device, detecting provision stoppage of a network service by the first device based on the network service provision state information, and generating a service stoppage request;
(k) storing a plurality of setting information of the first and second devices, which correspond to a network service before provision stoppage of the network service is detected; and
(l) calculating a service competition relation that is modified by the detected provision stoppage of the network service, according to both the service stoppage request and the information stored in step (e).
